(19) United States
(12) Patent Application Publication
(10) Pub. No.: US 2006/0159370 A1
(43) Pub. Date: Jul. 20, 2006

(54) Video retrieval system and video retrieval method

(75) Inventors: Noriko Tanaka, Tokyo (JP); Masaaki Sato, Tokyo (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Osaka (JP)

(21) Appl. No.: 11/296,994

(22) Filed: Dec. 8, 2005

(30) Foreign Application Priority Data
Dec. 10, 2004 (JP) P. 2004-358526

(51) Int. Cl. G06K 9/54; G06K 9/46; H04N 5/44

(52) U.S. Cl. 382/305; 382/190; 715/719

(57) ABSTRACT

A video retrieval apparatus and a video retrieval method capable of executing appropriately a video retrieval and executing an effective retrieval by easily designating a retrieved object are provided. A video retrieval apparatus, includes a moving region extracting portion 102 that extracts a stored object moving region in a video, a region dividing portion 104 that divides the stored object moving region into stored object block regions, a representative color deriving portion 105 that derives representative colors of respective stored object block regions constituting the stored object moving region, a DB 106 that stores respective representative colors of respective stored object block regions constituting the stored object moving region, a retrieved object region designating portion 108 that extracts a retrieved object region in a video, a region dividing portion 109 that divides the retrieved object region into retrieved object block regions, a representative color calculating portion 110 that derives representative colors of respective retrieved object block regions constituting the retrieved object region, and a comparing portion 111 that compares respective representative colors of the stored object block regions with respective representative colors of the retrieved object block regions, and outputs compared results.

### BACKGROUND OF THE INVENTION

The present invention relates to a video retrieval system and a video retrieval method used mainly for the video monitoring purpose.

Recently, various video retrieval systems (the monitoring systems or the individual identification systems) used for the video monitoring purpose in the individual identification, and the like have been proposed (see Patent Literatures 1 and 2, for example).

A block diagram of a monitoring system in the related art is shown in FIG. 14. The monitoring system shown in FIG. 14 includes a frame memory 512 for recording monitor images picked up by imaging devices 502 arranged in predetermined positions via an A/D converting portion 511, a process controlling portion 516 for reading sequentially the monitor images recorded in the frame memory 512, then designating at least a part of regions of the read monitor image in response to a user's operation of an operating portion 517, and then retrieving the monitor image in the designated region of which a motion is found, a display memory 520 for receiving the monitor image in the frame memory 512 retrieved by the process controlling portion 516 via a data compressing portion 513, a write buffer 514, a data recording portion 515, a read buffer 518 and a data expanding portion 519 and then reproducing the image, and a D/A converting portion 521, all being installed in a digital recorder 501, and a display device 505. In this monitoring system, only the video in which a motion is found in the region designated by the user's operation of the operating portion 517 is retrieved, extracted, and displayed at a high speed.

Also, an operation of an individual identifying system in the related art is shown in FIG. 15. The individual identifying system shown in FIG. 15 includes an image inputting portion 611 for inputting a face image of the person to be identified, a feature point extracting portion 613 that acquires the face image input by the image inputting portion 611 via a primary face normalizing portion 612 and extracting feature points of the face image, a standard face image feature point database portion 614 for recording the feature points of the standard face images, a standard face image database portion 616 for recording the standard face images that are deformed to coincide with the feature points of the standard face images every person, a secondary face normalizing portion 615 for deforming the face image being input by the image inputting portion 611 such that their feature points coincide with the feature points of the standard face images recorded in the standard face image feature point database portion 614, an image correlation calculating portion 617 for detecting sequentially a correlation between the face image normalized by the secondary face normalizing portion 615 and the standard face image recorded in the standard face image database portion 616, and a deciding portion 618 that identifies the person who has the face image input by the image inputting portion 611, based on a correlation value calculated by the image correlation calculating portion 617. This individual identifying system retrieves a standard face image that has the highest correlation with the input face image, and executes an identification of the individual based on the retrieved standard face image. This individual identifying system can execute the robust identification of the individual in answer to a change in the face shooting direction, and the like.

Also, in the video retrieval system in the related art, as the method of retrieving a desired person image by using color information, for example, followings are known. One method is that a similar image is acquired by designating the overall image as the retrieved object, then extracting the color information from the image, and then comparing the extracted color information with the color information extracted similarly from video data stored in the memory device. Also, when the color information is designated directly as attribute information, there is the method of inputting a rectangular area, or the like into the image displayed on a monitor via GUI to cut out a designated rectangular area, or the like from the displayed image, and then extracting the color information from the cut-out image as the retrieved object. Also, the “HSV space” described in this specification is disclosed in Non-Patent Literature 1, and the “histogram intersection” is disclosed in Patent Literature 3.

[Patent Literature 1] JP-A-2000-132669

[Patent Literature 2] JP-A-11-161791

[Patent Literature 3] JP-A-2004-252748 (Paragraphs 0012-0013)

[Non-Patent Literature 1] “Image Analysis Handbook”, supervised by Mikio Takagi and Haruhisa Shimoda, University of Tokyo Press, January 1991

However, since the image of the reproduced object is retrieved based on whether or not a motion is detected, the above monitoring systems in the related art are not always satisfactory for the video retrieving purpose to identify the particular object such as the identification of the individual, or the like. Meanwhile, when the image of the particular portion such as eyes, nose, mouse, or the like of the face cannot be acquired, the above individual identification system cannot execute the identification of the individual based on the retrieved result of the image. Therefore, the adequate video retrieving is required of these systems.

Also, in the video retrieval apparatus in the related art, for example, in the method of designating the image itself as the retrieval key, it is impossible to execute the retrieval when the user does not possess in advance the image to be retrieved beside him or her.

Also, in case the color information is designated directly as the attribute information, there is an individual difference every user when the method of designating the retrieved object region from which the color information is extracted by inputting the rectangular area into the image displayed on the monitor via GUI is employed. Therefore, it is possible that it is hard to get always the similar retrieval result.

### SUMMARY OF THE INVENTION

The present invention has been made to overcome the problems in the related art, and it is an object of the present invention to provide a video retrieval apparatus and a video retrieval method, capable of executing appropriately a video retrieving and executing an effective retriving by easily designating a retrieved object.

A video retrieval apparatus of the present invention includes a stored object moving region extracting unit that extracts a stored object moving region in a first video, and outputs a stored object moving region video signal corresponding to the stored object moving region; a stored object block region dividing unit that divides the stored object moving region into stored object block regions based on the stored object moving region video signal, and outputs stored object block region video signals corresponding to respective stored object block regions constituting the stored object moving region; a stored object block region representative color deriving unit that derives representative colors of respective stored object block regions constituting the stored object moving region based on the stored object block region video signals corresponding to respective stored object block regions to output; a stored object block region representative color storing unit that stores respective representative colors of the stored object block regions; a retrieved object region extracting unit that extracts a retrieved object region in a second video, and outputs a retrieved object region video signal corresponding to the retrieved object region; a retrieved object block region dividing unit that divides the retrieved object region into retrieved object block regions based on the retrieved object region video signal, and outputs retrieved object block region video signals corresponding to respective retrieved object block regions constituting the retrieved object region; a retrieved object block region representative color deriving unit that derives representative colors of respective retrieved object block regions constituting the retrieved object region based on the retrieved object block region video signals corresponding to respective retrieved object block regions to output; and a comparing unit that compares respective representative colors of the stored object block regions with respective representative colors of the retrieved object block regions, and outputs compared results.

According to this configuration, the video retrieval is conducted based on the motion in the video and the color of each block constituting the motion region. In other words, since the video retrieval is conducted by not only a motion in the picked-up video but also a color of the moving region, the video retrieval can be conducted more suitably than the case where the video retrieval is conducted based on the presence or absence of the motion or the case where the video of a particular portion of the object is needed in the video retrieval.

Also, in the video retrieval apparatus of the present invention, the comparing unit derives differential values between respective representative colors of the stored object block regions and respective representative colors of the retrieved object block regions as the compared results.

According to this configuration, since the region whose color is resemble for the retrieved object region can be retrieved out of a plurality of stored object moving regions, the video retrieval based on the color can be conducted suitably.

Also, in the video retrieval apparatus of the present invention, the comparing unit is constructed to derive a difference from digitized values of respective representative colors of the stored object block regions and digitized values of respective representative colors of the retrieved object block regions in accordance with a predetermined rule.

Also, in the video retrieval apparatus of the present invention further includes a person deciding unit that decides whether or not the stored object moving region satisfies predetermined conditions being set previously as conditions in which the stored object moving region is a person, based on the stored object moving region video signal, and outputs the stored object moving region video signal to the stored object block region dividing unit when the stored object moving region satisfies the predetermined conditions.

According to this configuration, only the color of the stored object moving region corresponding to the person can be set to the stored object. Thus, when the individual identification is to be conducted, it can be prevented that the color of unnecessary moving regions except the person is accumulated.

Also, in the video retrieval apparatus of the present invention, the stored object block region representative color deriving unit derives either a color corresponding to an average value of values, which are obtained by a conversion scheme to reduce an influence of a luminance change of occurring colors in the stored object block regions, or a color having a highest occurring frequency of the obtained values as the representative colors of the stored object block regions.

According to this configuration, the representative colors of the stored object block regions can be derived appropriately.

Also, in the video retrieval apparatus of the present invention, the retrieved object block region representative color deriving unit derives either a color corresponding to an average value of values, which are obtained by a conversion scheme to reduce an influence of a luminance change of occurring colors in the retrieved object block regions, or a color having a highest occurring frequency of the obtained values as the representative colors of the retrieved object block regions.

According to this configuration, the representative colors of the retrieved object block regions can be derived appropriately.

Also, a video retrieval method of the present invention of retrieving a motion object in a first video based on information in a second video, includes a stored object moving region extracting step of extracting a stored object moving region in a first video, and outputting a stored object moving region video signal corresponding to the stored object moving region; a stored object block region dividing step of dividing the stored object moving region into stored object block regions based on the stored object moving region video signal, and outputting stored object block region video signals corresponding to respective stored object block regions constituting the stored object moving region; a stored object block region representative color deriving step of deriving representative colors of respective stored object block regions constituting the stored object moving region based on the stored object block region video signals corresponding to respective stored object block regions to output; a stored object block region representative color storing step of storing respective representative colors of the stored object block regions; a retrieved object region extracting step of extracting a retrieved object region in a second video, and outputting a retrieved object region video signal corresponding to the retrieved object region; a retrieved object block region dividing step of dividing the retrieved object region into retrieved object block regions based on the retrieved object region video signal, and outputting retrieved object block region video signals corresponding to respective retrieved object block regions constituting the retrieved object region; a retrieved object block region representative color deriving step of deriving representative colors of respective retrieved object block regions constituting the retrieved object region based on the retrieved object block region video signals corresponding to respective retrieved object block regions to output; and a comparing step of comparing respective representative colors of the stored object block regions with respective representative colors of the retrieved object block regions, and outputting compared results.

Also, in the video retrieval method of the present invention, the comparing step derives differential values between respective representative colors of the stored object block regions and respective representative colors of the retrieved object block regions as the compared results.

Also, the video retrieval method of the present invention further includes a person deciding step of deciding whether or not the stored object moving region satisfies predetermined conditions being set previously as conditions in which the stored object moving region is a person, based on the stored object moving region video signal, and outputs the stored object moving region video signal when the stored object moving region satisfies the predetermined conditions; wherein, when the stored object moving region video signal is output in the person deciding step, the stored object block region dividing step divides the stored object moving region into stored object block regions based on the stored object moving region video signal, and outputs stored object block region video signals corresponding to respective stored object block regions constituting the stored object moving region.

Also, the video retrieval apparatus of the present invention includes a stored object moving region extracting unit that extracts a stored object moving region in a first video, and outputs a stored object moving region video signal corresponding to the stored object moving region; a stored object block region dividing unit that divides the stored object moving region into stored object block regions based on the stored object moving region video signal, and outputs stored object block region video signals corresponding to respective stored object block regions constituting the stored object moving region; a stored object block region color information generating unit that extracts color distributions from video signals contained in respective stored object block regions constituting the stored object moving region based on the stored object block region video signals corresponding to respective stored object block regions to output; a stored object block region color information storing unit that stores respective color information of the stored object block regions; a retrieved object region extracting unit that extracts a retrieved object region in a second video, and outputs a retrieved object region video signal corresponding to the retrieved object region; a retrieved object block region dividing unit that divides the retrieved object region into retrieved object block regions based on the retrieved object region video signal, and outputs retrieved object block region video signals corresponding to respective retrieved object block regions constituting the retrieved object region; a retrieved object block region color information generating unit that extracts color distributions from video signals contained in respective retrieved object block regions constituting the retrieved object region based on the retrieved object block region video signals corresponding to respective retrieved object block regions to output; and a comparing unit that compares respective color distributions of the stored object block regions with respective color distributions of the retrieved object block regions, and outputs compared results.

According to this configuration, the video retrieval is conducted based on the motion in the video and the color of each block constituting the motion region. In other words, since the video retrieval is conducted by not only a motion in the picked-up video but also a color of the moving region, the video retrieval can be conducted more suitably than the case where the video retrieval is conducted based on the presence or absence of the motion or the case where the video of a particular portion of the object is needed in the video retrieval.

Also, in the video retrieval apparatus of the present invention, the comparing unit derives consistencies in a color occurring frequency between respective color distributions of the stored object block regions and respective color distributions of the retrieved object block regions as the compared results.

Also, in the video retrieval apparatus of the present invention, the comparing unit derives a consistency in a color occurring frequency between respective color distributions of the stored object block regions and any of color distributions of the retrieved object block regions as the compared results.

Also, the video retrieval apparatus of the present invention further includes a person deciding unit that decides whether or not the stored object moving region satisfies predetermined conditions being set previously as conditions in which the stored object moving region is a person, based on the stored object moving region video signal, and outputs the stored object moving region video signal to the stored object block region dividing unit when the stored object moving region satisfies the predetermined conditions.

According to this configuration, since the regions having a similar rate of occurring number of respective colors in the retrieved object regions out of a plurality of stored object moving regions can be retrieved, the video retrieval based on the color can be conducted adequately.

Also, a video retrieval apparatus of the present invention, includes a stored object moving region extracting unit that extracts a stored object moving region in a first video, and outputs a stored object moving region video signal corresponding to the stored object moving region; a stored object block region dividing unit that divides the stored object moving region into stored object block regions based on the stored object moving region video signal, and outputs stored object block region video signals corresponding to respective stored object block regions constituting the stored object moving region; a stored object block region color information generating unit that extracts color distributions from video signals contained in respective stored object block regions constituting the stored object moving region based on the stored object block region video signals corresponding to respective stored object block regions to output; a stored object block region color information storing unit that stores respective color information of the stored object block regions; a retrieved object color information generating unit that extracts one retrieving object point in a second video, and extracts color information of the retrieving object point based on the retrieved object region video signal corresponding to the retrieved object point to output; and a comparing unit that generates representative color information from respective color distributions of the stored object block regions, compares the representative color information with the retrieved object color information, and then outputting compared results.

According to this configuration, when only one point is designated from the color information image indicated by the retrieval system in the situation that no image is present as the retrieved object, the video retrieval is conducted by not only a motion in the picked-up video but also a color of the moving region. Therefore, the video retrieval can be conducted more suitably than the case where the video retrieval is conducted based on the presence or absence of the motion or the case where the video of a particular portion of the object is needed in the video retrieval, and also the designation of the retrieved object can be made easily.

Also, in the video retrieval apparatus of the present invention, the comparing unit derives similarities of a color occurring frequency between the representative color information generated from respective color distributions of the stored object block regions and the color information of the retrieving object point as the compared results.

According to this configuration, since the region whose color is resemble for the retrieved object region can be retrieved out of a plurality of stored object moving regions, the video retrieval based on the color can be conducted suitably.

Also, a video retrieval apparatus of the present invention, includes a stored object moving region extracting unit that extracts a stored object moving region in a video, and outputs a stored object moving region video signal corresponding to the stored object moving region; a person motion scene deciding unit that identifies a same person from successive frame images in the video based on the stored object moving region video signal, and outputs the stored object moving region video signal and also outputs a motion scene end signal at a point of time when no motion is detected; a stored object block region dividing unit that divides the stored object moving region into stored object block regions based on the stored object moving region video signal, and outputs stored object block region video signals corresponding to respective stored object block regions constituting the stored object moving region; a stored object block region color information generating unit that extracts color feature parameters from video signals contained in respective stored object block regions constituting the stored object moving region every same person based on the stored object block region video signals corresponding to respective stored object block regions, and generates color distributions corresponding to respective stored object block regions every same person in response to the motion scene end signal to output; a retrieving area setting unit that sets a retrieved object region every same person based on the stored object moving region video signal, and outputs a retrieved object region video signal corresponding to the retrieved object region every same person in response to the motion scene end signal; a region color information storing unit that stores respective color information of the stored object block regions and the retrieved object region video signal corresponding to the retrieved object region; a person representative image list displaying unit that acquires the retrieved object region video signal from the region color information storing unit, and outputs a display list; a retrieved object region color information generating unit that generates a color distribution from a video signal contained in the retrieved object region based on the retrieved object region video signal to output; and a comparing unit that compares respective color distributions of the stored object block regions with respective color distributions of the retrieved object block regions, and outputs compared results.

According to this configuration, since the user can select the retrieved object person while checking a sheet of image per one person with eyes, such user can easily designate the retrieved object region. Also, since the retrieval is conducted while using the retrieved object region that has already been generated by selecting the person, the video retrieval based on the color can be conducted suitably.

Also, in the video retrieval apparatus of the present invention, the stored object block region dividing unit decides divided positions according to a shape of the person.

According to this configuration, the dress or the clothing of the person can be designated selectively as the retrieved object region. Thus, the video can be retrieved based on not only the color but also the further focused dress.

Also, a video retrieval method of the present invention of retrieving a motion object in a first video based on information in a second video, includes a stored object moving region extracting step of extracting a stored object moving region in a first video, and outputting a stored object moving region video signal corresponding to the stored object moving region; a stored object block region dividing step of dividing the stored object moving region into stored object block regions based on the stored object moving region video signal, and outputting stored object block region video signals corresponding to respective stored object block regions constituting the stored object moving region; a stored object block region color information generating step of extracting color distributions from video signals contained in respective stored object block regions constituting the stored object moving region based on the stored object block region video signals corresponding to respective stored object block regions to output; a stored object block region color information storing step of storing respective color information of the stored object block regions in a stored object block region storing unit; a retrieved object region extracting step of extracting a retrieved object region in a second video, and outputting a retrieved object region video signal corresponding to the retrieved object region; a retrieved object block region dividing step of dividing the retrieved object region into retrieved object block regions based on the retrieved object region video signal, and outputting retrieved object block region video signals corresponding to respective retrieved object block regions constituting the retrieved object region; a retrieved object block region color information generating step of extracting color distributions from video signals contained in respective retrieved object block regions constituting the retrieved object region based on the retrieved object block region video signals corresponding to respective retrieved object block regions to output; and a comparing step of comparing respective color distributions of the stored object block regions with respective color distributions of the retrieved object block regions, and outputting compared results.

Also, in the video retrieval method of the present invention, the comparing step derives consistencies in a color occurring frequency between respective color distributions of the stored object block regions and respective color distributions of the retrieved object block regions as the compared results.

Also, in the video retrieval method of the present invention, the comparing step derives a consistency in a color occurring frequency between respective color distributions of the stored object block regions and any of color distributions of the retrieved object block regions as the compared results.

Also, the video retrieval method of the present invention further includes a person deciding step of deciding whether or not the stored object moving region satisfies predetermined conditions being set previously as conditions in which the stored object moving region is a person, based on the stored object moving region video signal, and outputting the stored object moving region video signal when the stored object moving region satisfies the predetermined conditions; wherein, when the stored object moving region video signal is output in the person deciding step, the stored object block region dividing step divides the stored object moving region into stored object block regions based on the stored object moving region video signal, and outputs stored object block region video signals corresponding to respective stored object block regions constituting the stored object moving region.

Also, a video retrieval method of the present invention includes a stored object moving region extracting step of extracting a stored object moving region in a first video, and outputting a stored object moving region video signal corresponding to the stored object moving region; a stored object block region dividing step of dividing the stored object moving region into stored object block regions based on the stored object moving region video signal, and outputting stored object block region video signals corresponding to respective stored object block regions constituting the stored object moving region; a stored object block region color information generating step of extracting color distributions from video signals contained in respective stored object block regions constituting the stored object moving region based on the stored object block region video signals corresponding to respective stored object block regions to output; a stored object block region color information storing step of storing respective color information of the stored object block regions; a retrieved object color information generating step of extracting one retrieving object point in a second video, and extracting color information of the retrieving object point based on the retrieved object region video signal corresponding to the retrieved object point to output; and a comparing step of generating representative color information from respective color distributions of the stored object block regions, comparing the representative color information with the retrieved object color information, and then outputting compared results.

Also, in the video retrieval method of the present invention, the comparing step derives similarities of a color occurring frequency between the representative color information generated from respective color distributions of the stored object block regions and the color information of the retrieving object point as the compared results.

Also, a video retrieval method of the present invention includes a stored object moving region extracting step of extracting a stored object moving region in a video, and outputting a stored object moving region video signal corresponding to the stored object moving region; a person motion scene deciding step of identifying a same person from successive frame images in the video based on the stored object moving region video signal, and outputting the stored object moving region video signal and also outputting a motion scene end signal at a point of time when no motion is detected; a stored object block region dividing step of dividing the stored object moving region into stored object block regions based on the stored object moving region video signal, and outputting stored object block region video signals corresponding to respective stored object block regions constituting the stored object moving region; a stored object block region color information generating step of extracting color feature parameters from video signals contained in respective stored object block regions constituting the stored object moving region every same person based on the stored object block region video signals corresponding to respective stored object block regions, and generating color distributions corresponding to respective stored object block regions every same person in response to the motion scene end signal to output; a retrieving area setting step of setting a retrieved object region every same person based on the stored object moving region video signal, and outputting a retrieved object region video signal corresponding to the retrieved object region every same person in response to the motion scene end signal; a region color information storing step of storing respective color information of the stored object block regions and the retrieved object region video signal corresponding to the retrieved object region; a person representative image list displaying step of acquiring the retrieved object region video signal from the region color information storing unit, and outputting a display list; a retrieved object region color information generating step of generating a color distribution from a video signal contained in the retrieved object region based on the retrieved object region video signal to output; and a comparing step of comparing respective color distributions of the stored object block regions with respective color distributions of the retrieved object block regions, and outputs compared results.

Also, in the video retrieval apparatus of the present invention, the stored object moving region is set in plural.

According to this configuration, motions of a plurality of persons can be tracked and retrieved at the same time.

According to this configuration, since the video retrieval is conducted based on the motion in the picked-up video and colors of respective blocks constituting the moving regions, the video retrieval can be conducted more suitably than the case where the video retrieval is conducted based on the presence or absence of the motion or the case where the video of a particular portion of the object is needed in the video retrieval.

According to this configuration, when the user inputs the retrieved object, the retrieved object used to retrieve effectively the video of the person who is in similar color of the clothing can be easily designated by selecting the person image while checking the image of the person displayed on the monitor with eyes.

### BRIEF DESCRIPTION OF THE DRAWINGS

The objects and advantages of the present invention will be more obvious from the description in detailed description of the preferred embodiments with reference to the accompanying drawings.

FIG. 1 is a block diagram of a video retrieval apparatus in a first embodiment of the present invention;

FIG. 2 is a flowchart of operations of the video retrieval apparatus in accumulating a representative color in the first embodiment of the present invention;

FIG. 3 is a flowchart of operations of the video retrieval apparatus in retrieving a video in the first embodiment of the present invention;

FIG. 4 is a block diagram of a video retrieval apparatus in a second embodiment of the present invention;

FIG. 5 is a flowchart of operations of the video retrieval apparatus in accumulating a representative color in the second embodiment of the present invention;

FIG. 6 is a flowchart of operations of the video retrieval apparatus in retrieving a video in the second embodiment of the present invention;

FIG. 7 is a block diagram of a video retrieval apparatus in a fourth embodiment of the present invention;

FIG. 8 is a flowchart of operations of the video retrieval apparatus in accumulating a representative color in the fourth embodiment of the present invention;

FIG. 9 is a flowchart of operations of the video retrieval apparatus in accumulating a representative color in the fourth embodiment of the present invention;

FIG. 10 is a flowchart of operations of the video retrieval apparatus in retrieving a video in the fourth embodiment of the present invention;

FIG. 11A is a schematic view showing a person area in the fourth embodiment of the present invention;

FIG. 11B is a schematic view showing a person area divided in units of color information extraction in the fourth embodiment of the present invention;

FIG. 12 is a block diagram of a video retrieval apparatus in a third embodiment of the present invention;

FIG. 13 is a flowchart of operations of the video retrieval apparatus in retrieving a video in the third embodiment of the present invention;

FIG. 14 is a block diagram of a monitoring system in the related art; and

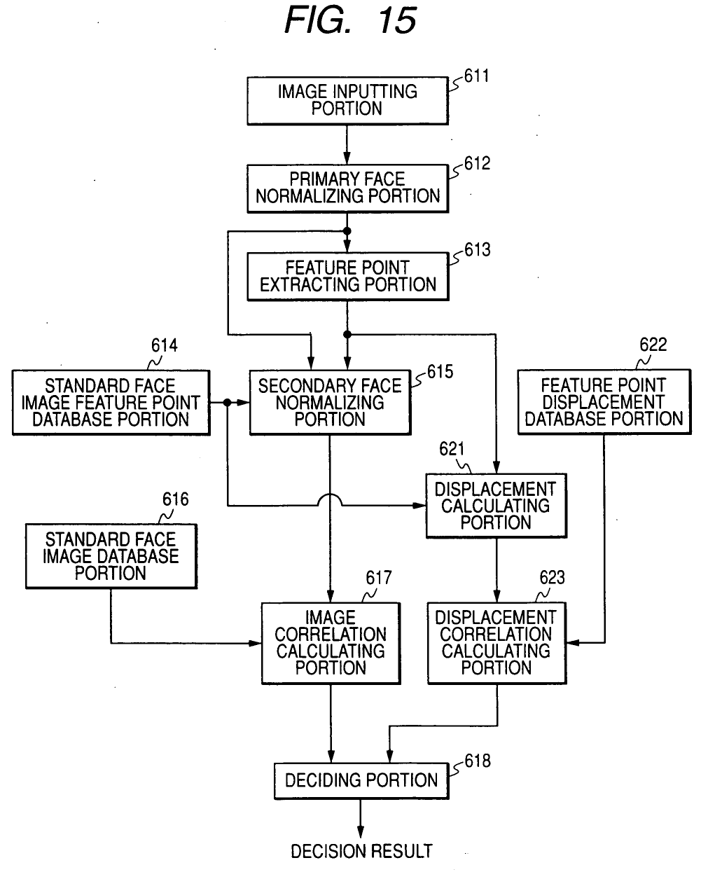

FIG. 15 is an individual identifying system in the related art.
100, 400, 700, 1100 video retrieval apparatus
101a to 101n video inputting portion
102a to 102n moving region extracting portion
103a to 103n person deciding portion
104a to 104n, 109 region dividing portion
105a to 105n, 110 representative color calculating portion
106, 402, 704 DB
107 keyboard
108 retrieving area designating portion
111, 404, 709, 1102 comparing portion
112 list displaying portion
113 video selecting portion
114 compressing portion
115 storage
116 video display instructing portion
117 expanding portion
118 displaying portion
401a to 401n, 403, 702a to 702n, 708, 1101 color information generating portion
701a to 701n person motion scene deciding portion
703a to 703n retrieving area setting portion
705 user's instruction inputting portion
706 person representative image list displaying portion
707 retrieved object selecting portion

### DETAILED DESCRIPTION OF THE PREFERRED EMBODIMENTS

A video retrieval apparatus according to embodiments of the present invention will be explained with reference to the drawings hereinafter.

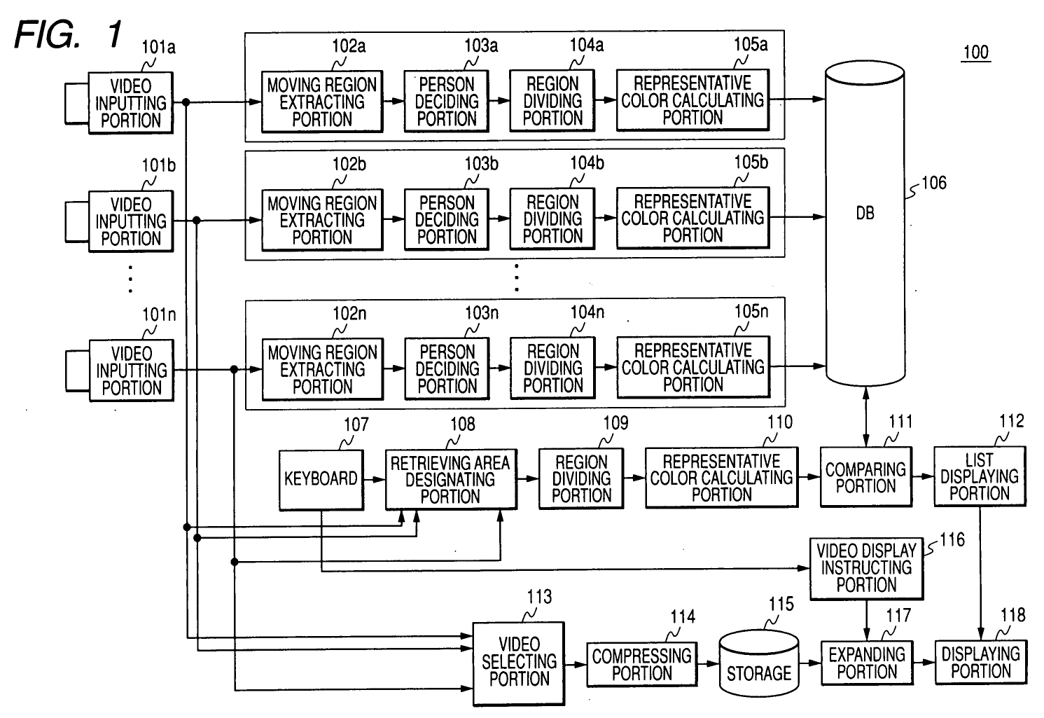

A block diagram of a video retrieval apparatus in a first embodiment of the present invention is shown in FIG. 1. In FIG. 1, a video retrieval apparatus 100 includes video inputting portions 101a to 101n that pick up an image of a subject to generate/output a video signal respectively (these video inputting portions 101a to 101n are referred together to appropriately as a “video inputting portion 101” hereinafter). Also, this system includes moving region extracting portions 102a to 102n that receive the video signal from the corresponding video inputting portion 101, extract a moving region (stored object moving region) in the video, and output the video signal corresponding to the stored object moving region (stored object moving region video signal) respectively (these moving region extracting portions 102a to 102n are referred together to appropriately as a “moving region extracting portion 102” hereinafter). Also, this system includes person deciding portions 103a to 103n that receive the stored object moving region video signal from the moving region extracting portion 102, decide whether or not the stored object moving region satisfies the conditions required for the predetermined person, and output the stored object moving region video signal respectively when the conditions required for the person are satisfied (these person deciding portions 103a to 103n are referred together to appropriately as a “person deciding portion 103” hereinafter). Also, this system includes region dividing portions 104a to 104n that receive the stored object moving region video signal from the corresponding person deciding portion 103, divide the stored object moving region into a plurality of block regions (stored object block regions), and output the video signal corresponding to the stored object block region (stored object block region video signal) respectively (these region dividing portions 104a to 104n are referred together to appropriately as a “region dividing portion 104” hereinafter). Also, this system includes representative color calculating portions 105a to 105n that receive the stored object block region video signal from the corresponding region dividing portion 104, and calculate/output a representative color of the stored object block region constituting the stored object moving region respectively (these representative color calculating portions 105a to 105n are referred together to appropriately as a “representative color calculating portion 105” hereinafter).

Also, the video retrieval apparatus 100 includes a database (DB) 106 that stores the representative colors of respective stored object block regions constituting the stored object moving regions from the representative color calculating portions 105. Also, this system includes a keyboard 107 that the user uses to input the instruction, and a retrieving area designating portion 108 that receives the video signal from the video inputting portion 101, designates a predetermined region (retrieved object region) in the video as the retrieved object in response to the user's operation of the keyboard 107, and outputs the video signal corresponding to the retrieved object region (retrieved object region video signal). Also, this system includes a region dividing portion 109 that receives the retrieved object region video signal from the retrieving area designating portion 108, divides the retrieved object region into a plurality of block regions (retrieved object block regions), and outputs the video signals corresponding to the retrieved object block regions (retrieved object block region video signals). Also, this system includes a representative color calculating portion 110 that receives the retrieved object block region video signals from the region dividing portion 109, and calculates/outputs the representative colors of respective retrieved object block regions constituting the retrieved object region.

Also, the video retrieval apparatus 100 includes a comparing portion 111 that compares the representative color of the retrieved object block regions constituting the retrieved object region from the representative color calculating portion 110 with the representative color of the stored object block regions constituting the stored object moving region in the DB 106, and outputs the retrieved result in response to the comparison result. Also, this system includes a list displaying portion 112 that generates/outputs a list of the retrieved result to display the retrieved result in the comparing portion 111. Also, this system includes a video selecting portion 113 for selecting/outputting the to-be-recorded video signal out of the video signal from the video inputting portion 101, a compressing portion 114 for compressing the video signal from the video selecting portion 113, and a storage 115 that stores the compressed video signal from the compressing portion 114. Also, this system includes a video display instructing portion 116 for instructing to display the video in response to the user's operation of the keyboard 107, an expanding portion 117 for expanding the compressed video signal in the storage 115 in response to the instruction made by the video display instructing portion 116, and a displaying portion 118 for displaying the video to correspond to a list of the retrieval result by the comparing portion 111 or the video signal expanded by the expanding portion 117.

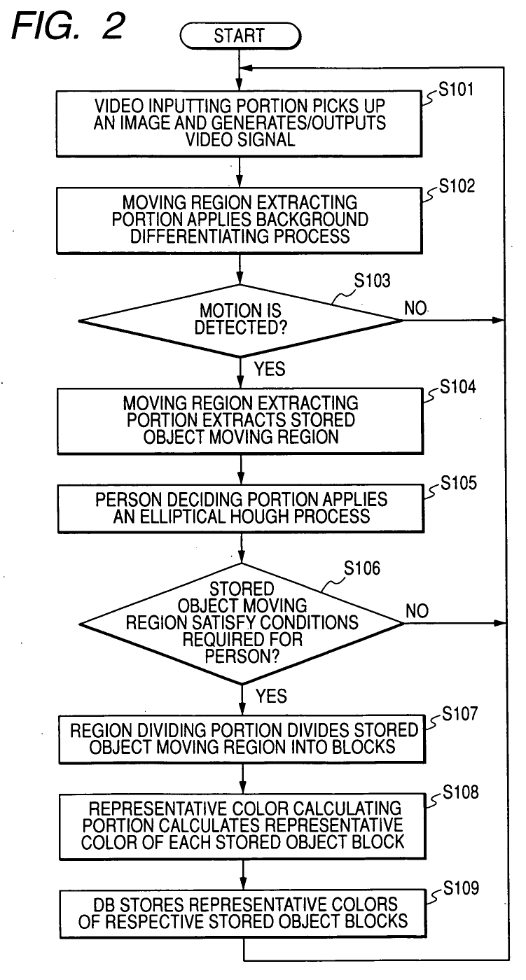

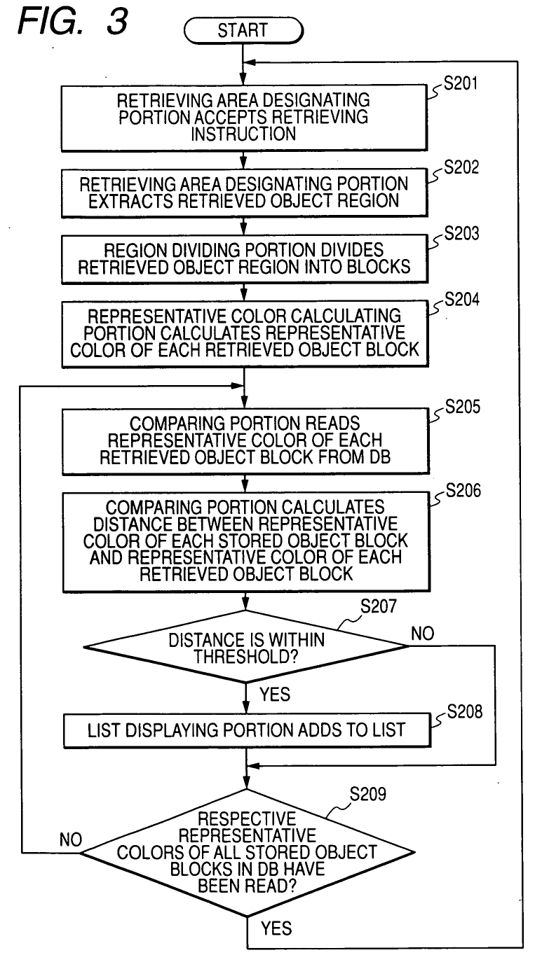

Then, operations of the video retrieval apparatus 100 constructed as above will be explained with reference to FIG. 2 and FIG. 3 hereunder. First, an operation in accumulating a representative color will be explained with reference to FIG. 2 hereunder.

The video inputting portion 101 picks up an image of a subject and generates a video signal (S101). Then, the video inputting portion 101 outputs the generated video signal to the moving region extracting portion 102. For example, the video inputting portion 101a outputs the generated video signal to the moving region extracting portion 102a.

The moving region extracting portion 102, when receives the video signal from the corresponding video inputting portion 101, applies a background differentiating process to calculate a differential value between the video corresponding to the video signal and the background video held previously (S102). Then, the moving region extracting portion 102 decides whether or not a motion is detected from the video corresponding to the input video signal (S103). Concretely, the moving region extracting portion 102 decides that the motion is detected when the differential value is larger than a predetermined value in the background differentiating process in S102, but decides that no motion is detected when the differential value is not so. In this case, the moving region extracting portion 102 may apply the process other than the background differentiating process in S102 and then may decide whether or not a motion is detected from the video, in response to the result of the process other than the background differentiating process in S103.

When no motion is detected from the video corresponding to the video signal being input into the moving region extracting portion 102, the operations subsequent to shooting of the subject and generation of the video signal executed by the video inputting portion 101 (S101) are repeated.

In contrast, when the motion is detected from the video corresponding to the video signal being input into the moving region extracting portion 102, the moving region extracting portion 102 extracts a moving region in the video (stored object moving region)(S104). Then, the moving region extracting portion 102 outputs a stored object moving region video signal corresponding to the extracted stored object moving region to the corresponding person deciding portion 103. For example, the moving region extracting portion 102a outputs the stored object moving region video signal corresponding to the extracted stored object moving region to the person deciding portion 103a.

The person deciding portion 103, when receives the stored object moving region video signal from the corresponding moving region extracting portion 102, applies an elliptical Hough process to the video in the stored object moving region corresponding to the stored object moving region video signal (S105). Then, the person deciding portion 103 decides whether or not the stored object moving region corresponding to the input stored object moving region video signal satisfies conditions required for the person (S106). Concretely, when an elliptical area that looks like a face of a person can be detected from the video in the stored object moving region by the elliptical Hough process in S105, the person deciding portion 103 decides that the stored object moving region satisfies the conditions required for the person. In contrast, when the elliptical area that looks like a face of a person cannot be detected, the person deciding portion 103 decides that the stored object moving region does not satisfy the conditions required for the person. In this case, the person deciding portion 103 may apply the process other than the elliptical Hough process (e.g., the process of deriving a shape, a size, or the like of the whole stored object moving region) in S105 and then may decide whether or not the stored object moving region satisfies the conditions required for the person, in response to the result of the process other than the elliptical Hough process in S106.

When the stored object moving region corresponding to the stored object moving region video signal does not satisfy the conditions required for the person, the operations subsequent to the shooting of the subject and the generation of the video signal executed by the video inputting portion 101 (S101) are repeated.

In contrast, when the stored object moving region corresponding to the stored object moving region video signal satisfies the conditions required for the person, the person deciding portion 103 outputs the input stored object moving region video signal to the corresponding region dividing portion 104. For example, the person deciding portion 103a outputs the input stored object moving region video signal to the region dividing portion 104a.

The region dividing portion 104 receives the stored object moving region video signal from the corresponding person deciding portion 103, and divides the stored object moving region corresponding to the stored object moving region video signal into a plurality of blocks (stored object block regions) (S107). When the region dividing portion 104 divides the stored object moving region into four blocks, such region dividing portion counts pixels of the stored object moving region in both the longitudinal direction and the lateral direction and then specifies a middle point in the longitudinal direction and a middle point in the lateral direction. Then, the region dividing portion 104 divides the stored object moving region into two blocks in the longitudinal direction while using a middle point in the longitudinal direction as a divided position and divides the stored object moving region into two blocks in the lateral direction while using a middle point in the lateral direction as a divided position. Thus, the stored object moving region is divided into four stored object block regions. Here, the divided number of the stored object moving region and a shape of the stored object block regions are not particularly limited.

Then, the region dividing portion 104 outputs the video signal corresponding to the stored object block regions constituting the stored object moving region (stored object block region video signal) to the corresponding representative color calculating portion 105. For example, the region dividing portion 104a outputs the stored object block region video signal to the representative color calculating portion 105a.

When the representative color calculating portion 105 receives the stored object block region video signal corresponding to the stored object block regions constituting the stored object moving region from the corresponding region dividing portion 104, such representative color calculating portion calculates a representative color of respective stored object block regions constituting the stored object moving region based on the stored object block region video signal (S108). Concretely, the representative color calculating portion 105 calculates a color that corresponds to an average value of the values, which are decided in compliance with a predetermined rule (transformation rule to reduce the influence of change of a luminance in representing the values in the RGB calorimetric system by the HSV calorimetric system), with respect to the colors that occur in the stored object block regions or a color that has a highest occurring frequency in the stored object block regions, as the representative color of respective stored object block regions.

Then, the representative color calculating portion 105 outputs the representative color of respective stored object block regions constituting the stored object moving region to the DB 106. The DB 106 stores the representative color of respective stored object block regions constituting the stored object moving region from the representative color calculating portion 105 (S109). Here, the DB 106 may store data of an identification information (ID) of the camera 102 that picks up the video containing the stored object moving region, a shooting data and time, and a thumbnail video, in which the video corresponding to the stored object moving region is reduced, so as to correlate with the representative color of respective stored object block regions constituting the stored object moving region.

After the above processes in S101 to S109 are repeated, the representative colors of a plurality of stored object block regions constituting the stored object moving region are accumulated in the DB 106.

Next, an operation in retrieving the video will be explained with reference to FIG. 3 hereunder.

The user operates the keyboard 107 while watching the video displayed on the displaying portion 118, and issues the instruction (retrieving instruction) to designate the person in the video as the retrieved object. Then, the retrieving area designating portion 108 accepts the retrieving instruction issued from the user (S201). Then, the retrieving area designating portion 108 receives the video signal corresponding to the video displayed on the displaying portion 118 from the video inputting portion 101, and extracts a moving region instructed by the user (retrieved object region) (S202). Then, the retrieving area designating portion 108 outputs the retrieved object region video signal corresponding to the extracted retrieved object region to the region dividing portion 109.

The region dividing portion 109 receives the retrieved object region video signal from the retrieving area designating portion 108, and divides the retrieved object region corresponding to the retrieved object region video signal into a plurality of block regions (retrieved object block regions) (S203). When the retrieved object region is divided into four blocks, the region dividing portion 109 counts pixels of the retrieved object region in both the longitudinal direction and the lateral direction and then specifies a middle point in the longitudinal direction and a middle point in the lateral direction, like the region dividing portion 104. Then, the region dividing portion 109 divides the retrieved object region into two blocks in the longitudinal direction while using a middle point in the longitudinal direction as a divided position and divides the retrieved object region into two blocks in the lateral direction while using a middle point in the lateral direction as a divided position. Thus, the retrieved object region is divided into four retrieved object block regions. Here, the divided number of the retrieved object region and a shape of the retrieved object region are not particularly limited. Then, the region dividing portion 109 outputs the video signal corresponding to respective retrieved object block regions constituting the retrieved object region (retrieved object block region video signal) to the representative color calculating portion 110.

The representative color calculating portion 110, when receives the retrieved object block region video signal corresponding to the retrieved object block regions constituting the retrieved object region from the region dividing portion 109, calculates the representative color of the retrieved object block regions constituting the retrieved object region based on the retrieved object block region video signal (S204). Concretely, like the representative color calculating portion 105, the representative color calculating portion 110 calculates a color that corresponds to an average value of the values, which are decided in compliance with a predetermined rule, with respect to the colors that occur in the retrieved object block regions or a color that has a highest occurring frequency in the retrieved object block regions, as the representative color of respective retrieved object block regions. Then, the representative color calculating portion 110 outputs the representative colors of the retrieved object block regions constituting the retrieved object region to the comparing portion 111.

The comparing portion 111, when receives the representative colors of the retrieved object block regions constituting the retrieved object region from the representative color calculating portion 110, reads the representative color of each retrieved object block region constituting any stored object moving region from the DB 106 (S205).

Then, the comparing portion 111 calculates a distance between the numerical value corresponding to the representative color of each stored object block constituting the read stored object moving region and the numerical value corresponding to the representative color of each retrieved object block constituting the input retrieved object region (S206).

As the representative color, the numerical value corresponding to RGB color information or the numerical value corresponding to lightness, saturation, or the like is employed. In this case, the digitization to reduce a difference between the numerical values smaller as the colors more closely resemble is employed. For example, such a case may be supposed that four regions (A1, A2, A3, A4) are set as the stored object block regions constituting the stored object moving region and also the numerical value of the representative color of the stored object block region A1 is given by a1, the numerical value of the representative color of the stored object block region A2 is given by a2, the numerical value of the representative color of the stored object block region A3 is given by a3, and the numerical value of the representative color of the stored object block region A4 is given by a4 whereas four regions (B1 corresponding to the stored object block region A1, B2 corresponding to the stored object block region A2, B3 corresponding to the stored object block region A3, B4 corresponding to the stored object block region A4) are set as the retrieved object block regions constituting the retrieved object region and also the numerical value of the representative color of the retrieved object block region B1 is given by b1, the numerical value of the representative color of the retrieved object block region B2 is given by b2, the numerical value of the representative color of the retrieved object block region B3 is given by b3, and the numerical value of the representative color of the retrieved object block region B4 is given by b4. In this case, the comparing portion 111 represents the numerical value of the representative color of the stored object block region on four-dimensional space coordinates (a1, a2, a3, a4) and also represents the numerical value of the representative color of the retrieved object block region on four-dimensional space coordinates (b1, b2, b3, b4), and calculates a Euclidean distance between these coordinates. Here, the comparing portion 111 may calculate a distance other than the Euclidean distance.

Then, the comparing portion 111 decides whether or not the distance between the numerical value corresponding to the representative color of the stored object block regions constituting the calculated stored object moving region and the numerical value corresponding to the representative color of the retrieved object block regions constituting the retrieved object region is within a predetermined threshold value (S207). Here, it is desirable that the user can set freely the threshold value.

When the distance between the numerical value corresponding to the representative color of the stored object block regions constituting the stored object moving region and the numerical value corresponding to the representative color of the retrieved object block regions constituting the retrieved object region is within the predetermined threshold value, the comparing portion 111 outputs the data related to the representative color of the stored object block regions constituting the stored object moving region (e.g., data of an identification information (ID) of the camera 102 that picks up the video containing the stored object moving region, a shooting data and time, and a thumbnail video in which the video of the stored object moving region is reduced) to the list displaying portion 112 as the retrieved result. The list displaying portion 112 adds the data related to the representative color of the stored object block regions constituting the stored object moving region from the comparing portion 111 to the retrieved result list (S208).

After the list displaying portion 112 adds the data to the retrieved result list (S208) or after the comparing portion 111 decides that the distance between the numerical value corresponding to the representative color of the stored object block regions constituting the calculated stored object moving region and the numerical value corresponding to the representative color of the retrieved object block regions constituting the retrieved object region exceeds the predetermined threshold value (negative decision in S207), the comparing portion 111 decides whether or not the representative colors of the stored object block regions constituting all stored object moving regions in the DB 106 have been read (S209). When the representative color of the stored object block regions constituting the stored object moving region that has not been read yet remains in the DB 106, operations subsequent to the reading operation of the representative color of the retrieved object block regions constituting the stored object moving region, which has not been read yet, by the comparing portion 111 (S205) are repeated.

In contrast, when the comparing portion 111 reads the representative color of the stored object block regions constituting all stored object moving regions in the DB 106, operations subsequent to the acceptance of the retrieving instruction by the retrieving area designating portion 108 (S201) are repeated. Then, the retrieved result list generated by the list displaying portion 112 is displayed on the displaying portion 118, so that the user can recognize the retrieved result.

In FIG. 3, the case where the user designates the moving region as the retrieved object region is explained. But the video retrieval can be conducted similarly when the person as the retrieved object is at rest and the region of the rest person is designated as the retrieved object region. In this case, like FIG. 3, the retrieving area designating portion 108 extracts the region designated by the user (retrieved object region) and outputs the retrieved object region video signal corresponding to the extracted retrieved object region to the region dividing portion 109.

In this manner, in the video retrieval apparatus 100, when the moving region in the video picked up by the video inputting portion 101 satisfies the conditions required for the person, the moving region is divided into a plurality of stored object block regions and then the representative colors of the stored object block regions are calculated and stored in the DB 106. Then, in retrieving the video, the retrieved object region designated by the user is divided into a plurality of retrieved object block regions, then the representative color of the retrieved object block is calculated, and then the data associated with the representative color of the stored object block regions constituting the stored object region that are similar to the representative color of the retrieved object block regions constituting the retrieved object region are offered to the user as the retrieved result. In other words, since the video retrieval is conducted by not only a motion in the picked-up video but also a color of the moving region, the video retrieval can be conducted more suitably than the case where the video retrieval is conducted based on the presence or absence of the motion or the case where the video of a particular portion of the object is needed in the video retrieval.

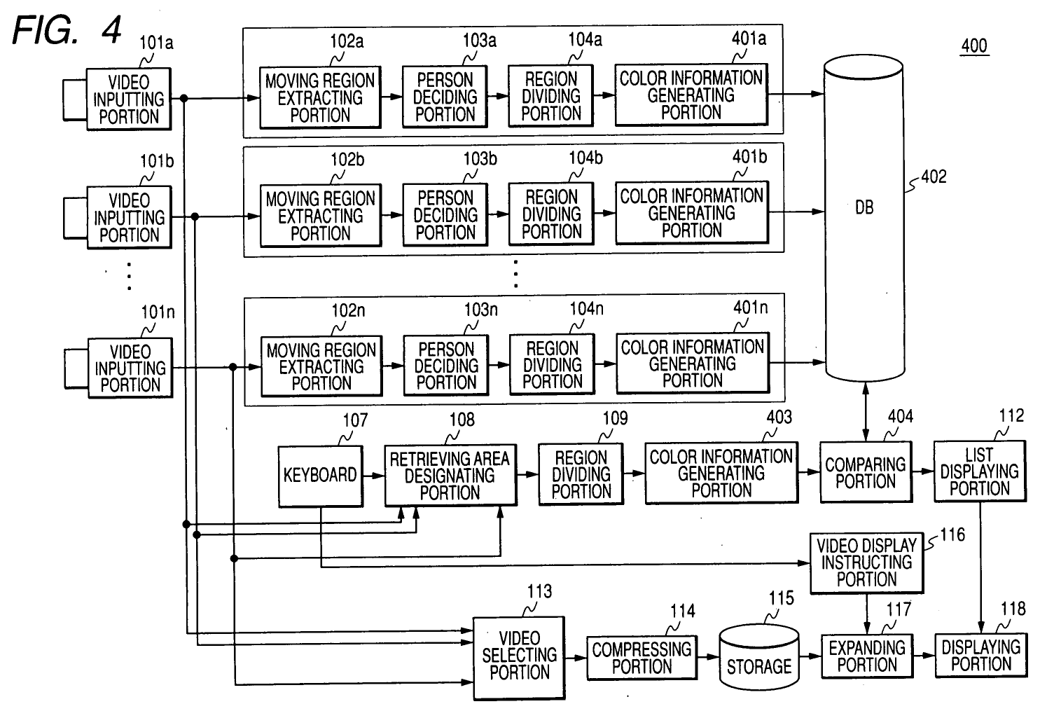

Next, a block diagram of a video retrieval apparatus 400 in a second embodiment of the present invention is shown in FIG. 4. In FIG. 4, the same reference symbols as the video retrieval apparatus 100 are affixed to the similar constituent elements to those in the first embodiment, and their explanation will be omitted herein.

A video retrieval apparatus 400 includes color information generating portions 401a to 401n that receive the stored object block region video signal from the corresponding region dividing portion 104, extract color feature parameters of the stored object block regions constituting the stored object moving region, and generate/output a color distribution respectively (these color information generating portions 401a to 401n are referred together to appropriately as a “color information generating portion 401” hereinafter). Also, this system includes a database (DB) 402 that stores the color distribution of the stored object block regions constituting the stored object moving region from the color information generating portion 401, a color information generating portion 403 for receiving the retrieved object block video signal from the region dividing portion 109, extracting color feature parameters of the retrieved object blocks constituting the retrieved object region, and generating/outputting a color distribution, and a comparing portion 404 that compares the color distribution of the retrieved object block regions constituting the retrieved object region from the color information generating portion 403 with the color distribution of the stored object block regions constituting the stored object moving region in a DB 402 and outputs the retrieved result in response to the compared result.

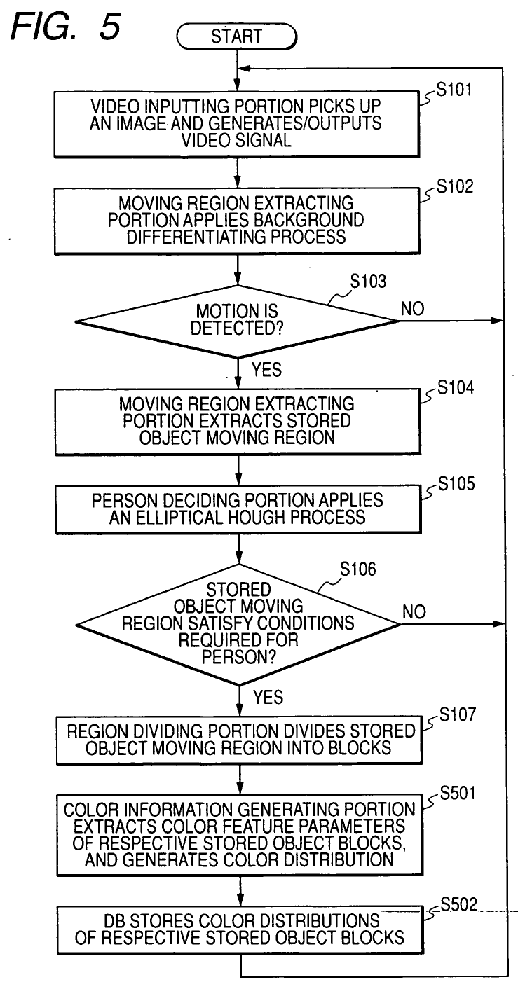

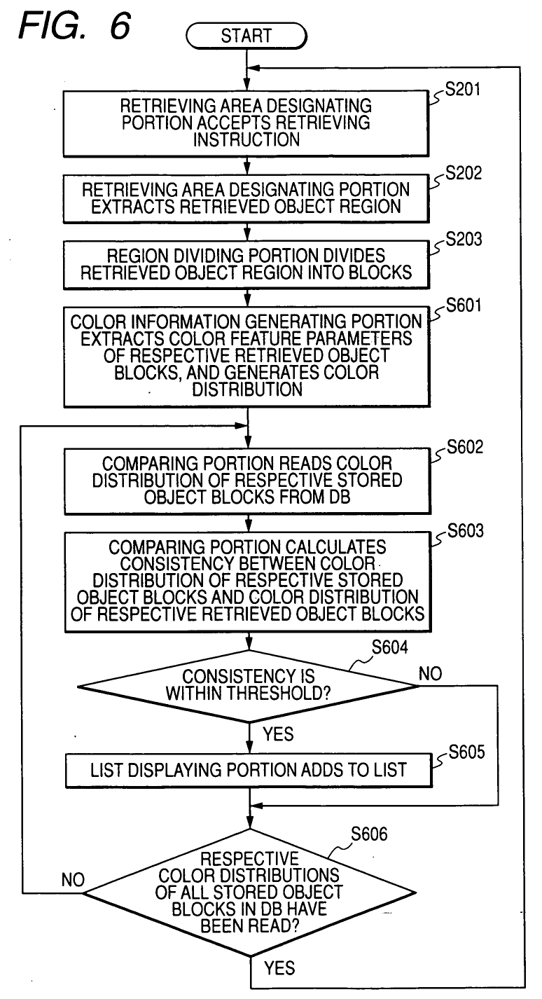

Next, operations of the video retrieval apparatus 400 constructed as above will be explained with reference to FIG. 5 and FIG. 6 hereunder. First, an operation in accumulating the color distribution will be explained with reference to FIG. 5 hereunder. The same reference symbols are affixed to the similar process steps to those in the first embodiment, and explanation of their operation will be simplified herein.

The video inputting portion 101 picks up an image of the subject and generates the video signal (S101). Then, the video inputting portion 101 outputs the generated video signal to the corresponding moving region extracting portion 102.

The moving region extracting portion 102, when receives the video signal from the corresponding video inputting portion 101, applies a background differentiating process to calculate a differential value between the video corresponding to the video signal and the background video held previously (S102). Then, the moving region extracting portion 102 decides whether or not the motion is detected in the video corresponding to the input video signal (S103).

When no motion is detected in the video corresponding to the video signal being input into the moving region extracting portion 102, operations subsequent to the shooting of the subject and the generation of the video signal by the video inputting portion 101 (S101) are repeated.

In contrast, when the motion is detected in the video corresponding to the video signal being input into the moving region extracting portion 102, the moving region extracting portion 102 extracts a moving region in the video (stored object moving region) (S104). Then, the moving region extracting portion 102 outputs the stored object moving region video signal corresponding to the extracted stored object moving region to the corresponding person deciding portion 103.

When the person deciding portion 103 receives the stored object moving region video signal from the corresponding moving region extracting portion 102, such person deciding portion 103 applies the elliptical Hough process to the video in the stored object moving region corresponding to the stored object moving region video signal (S105). Then, the person deciding portion 103 decides whether or not the stored object moving region corresponding to the input stored object moving region video signal satisfies the conditions required for the person (S106).

When the stored object moving region corresponding to the input stored object moving region video signal does not satisfy the conditions required for the person, operations subsequent to the shooting of the subject and the generation of the video signal by the video inputting portion 101 (S101) are repeated.

In contrast, when the stored object moving region corresponding to the input stored object moving region video signal satisfies the conditions required for the person, the person deciding portion 103 outputs the input stored object moving region video signal to the corresponding region dividing portion 104.

The region dividing portion 104 receives the stored object moving region video signal from the corresponding person deciding portion 103, and then divides the stored object moving region corresponding to the stored object moving region video signal into a plurality of block regions (stored object block regions) (S107).

Then, the region dividing portion 104 outputs the video signal corresponding to the stored object block regions constituting the stored object moving region (stored object block region video signal) to the corresponding color information generating portion 401.

When the color information generating portion 401 receives the stored object block region video signal corresponding to the stored object block regions constituting the stored object moving region from the corresponding region dividing portion 104, it generates the color information of the stored object block regions constituting the stored object moving region based on the stored object block region video signal (S501). Concretely, the color information generating portion 401 acquires RGB values of respective pixels of the stored object block region video as the color information, then converts them into the HSV space (see Non-Patent Literature 1), and then forms the histogram (called a “color distribution” hereinafter) using H, S. Here, the color space is converted from RGB to HSV, but other color spaces (e.g., XYX, YcrCb, or the like) can also be utilized by the normal usage (the histogram is generated by the XY plane, the CrCb plane).

Also, the color information generating portion 401 outputs the color distribution of the stored object block regions constituting the stored object moving region to the DB 402. The DB 402 stores the color distributions of the stored object block regions constituting the stored object moving region from the color information generating portion 401 (S502). In this case, the DB 402 may store the data of an identification information (ID) of the camera 102 that picks up the video containing the stored object moving region, a shooting data and time, and a thumbnail video, in which the video corresponding to the stored object moving region is reduced, so as to correlate with the color distribution of respective stored object block regions constituting the stored object moving region.

Then, since the above processes in S101 to S107 and S501, S502 are repeated, the color distribution of the stored object block regions constituting a plurality of stored object moving regions are stored in the DB 402.

Next, an operation in retrieving the video will be explained with reference to FIG. 6 hereunder.

The user operates the keyboard 107 while watching the video displayed on the displaying portion 118, and issues the instruction (retrieving instruction) to designate the person in the video as the retrieved object. Then, the retrieving area designating portion 108 accepts the retrieving instruction issued from the user (S201). Then, the retrieving area designating portion 108 receives the video signal corresponding to the video displayed on the displaying portion 118 from the video inputting portion 101, and extracts a moving region instructed by the user (retrieved object region) (S202). Then, the retrieving area designating portion 108 outputs the retrieved object region video signal corresponding to the extracted retrieved object region to the region dividing portion 109.

The region dividing portion 109 receives the retrieved object region video signal from the retrieving area designating portion 108, and divides the retrieved object region corresponding to the retrieved object region video signal into a plurality of block regions (retrieved object block regions) (S203). Then, the region dividing portion 109 outputs the video signal corresponding to the retrieved object block regions constituting the retrieved object region (retrieved object block region video signal) to the color information generating portion 403.

When the color information generating portion 403 receives the retrieved object region video signal corresponding to the retrieved object region from the region dividing portion 109, it generates the color distribution of the retrieved object region based on the retrieved object region video signal (S601). Concretely, like the above color information generating portion 401, the color information generating portion 403 acquires RGB values of respective pixels of the stored object block region video as the color information, then converts them into the HSV space, and then forms the color distribution. Here, the color space is converted from RGB to HSV, but other color spaces (e.g., XYX, YcrCb, or the like) can also be utilized by the normal usage (the histogram is generated by the XY plane, the CrCb plane). Also, the color information generating portion 403 outputs the color distribution of the retrieved object region to the comparing portion 404.

When the comparing portion 404 receives the color distribution of the retrieved object region from the color information generating portion 403, it reads the color distribution of the stored object block regions constituting any stored object moving region from the DB 402 (S602).

Then, the comparing portion 404 compares the color distribution of the stored object block regions constituting the read stored object moving region with the color distribution of the retrieved object block regions constituting the input retrieved object region, and then calculates a consistency between them (S603).

Since the color distribution is two-dimensional histogram using H, S, the histogram intersection (see Patent Literature 3), for example, may be employed to calculate a consistency. According to this system, a consistency derived when both color distributions are completely consistent is given as the value that is obtained by integrating all frequencies contained in the color distribution of the retrieved object block regions constituting the retrieved object region, and a consistency is 0 when both are completely inconsistent.

Consistencies between respective color distributions of the stored object block regions constituting the stored object moving region and the color distribution of the retrieved object block regions constituting the retrieved object region can also be derived, and these values are called again a partial consistency respectively. The consistency is calculated by integrating all partial consistencies. Also, the stored object block regions are selected as the comparative object in answer to the purpose to calculate the partial consistency, and then the consistency can be calculated by integrating only the calculated partial consistencies.

The histogram intersection is employed herein, but the others may be considered as the method of comparing two color distributions. For example, the method of extracting color distribution positions whose frequency is larger than a previously set threshold value and then comparing the color distribution positions and rates of the frequencies among them may be considered.

Then, the comparing portion 404 decides whether or not the consistency between the color distribution of the stored object block regions constituting the calculated stored object moving region and the color distribution of the retrieved object block regions constituting the retrieved object region is within a predetermined threshold value (S604). Here, it is desirable that the user can set freely the threshold value.

When the consistency between the color distribution of the stored object block regions constituting the stored object moving region and the color distribution of the retrieved object block regions constituting the retrieved object region is within the predetermined threshold value, the comparing portion 404 outputs the data related to the stored object moving region containing the stored object block regions constituting the stored object moving region (e.g., data of an identification information (ID) of the camera 102 that picks up the video containing the stored object moving region, a shooting data and time, and a thumbnail video in which the video of the stored object moving region is reduced) to the list displaying portion 112 as the retrieved result. The list displaying portion 112 adds the data related to the stored object moving region containing the stored object block regions constituting the stored object moving region from the comparing portion 404 to the retrieved result list (S605).

After the list displaying portion 112 adds the data to the retrieved result list (S605) or after the comparing portion 404 decides that the consistency between the color distribution of the stored object block regions constituting the stored object moving region and the color distribution of the retrieved object block regions constituting the retrieved object region exceeds the predetermined threshold value (negative decision in S604), the comparing portion 404 decides whether or not the color distributions of the stored object block regions constituting all stored object moving regions in the DB 402 have been read (S606). When the color distribution of the stored object block regions constituting the stored object moving region that has not been read remains in the DB 402, operations subsequent to the reading operation of the color distribution of the retrieved object block regions constituting the stored object moving region, which has not been read yet, by the comparing portion 404 (S602) are repeated.

In contrast, when the comparing portion 404 reads the color distribution of the stored object block regions constituting all stored object moving regions in the DB 402, operations subsequent to the acceptance of the retrieving instruction by the retrieving area designating portion 108 (S201) are repeated. Then, the retrieved result list generated by the list displaying portion 112 is displayed on the displaying portion 118, so that the user can recognize the retrieved result.

In FIG. 6, the case where the user designates the moving region as the retrieved object region is explained. But the video retrieval can be conducted similarly when the person as the retrieved object is at rest and the region of the rest person is designated as the retrieved object region. In this case, like FIG. 6, the retrieving area designating portion 108 extracts the region designated by the user (retrieved object region) and then outputs the retrieved object region video signal corresponding to the extracted retrieved object region to the color information generating portion 403.

In this manner, in the video retrieval apparatus 400, when the moving region in the video picked up by the video inputting portion 101 satisfies the conditions required for the person, the moving region is divided into a plurality of stored object block regions and then the color distributions of the stored object block regions are generated and stored in the DB 402. Then, in retrieving the video, the color distribution of the retrieved object region designated by the user is generated, and then the data associated with the stored object region containing the stored object block regions constituting the stored object region that are similar to the color distribution of the retrieved object region are offered to the user as the retrieved result. In other words, since the video retrieval is conducted by not only a motion in the picked-up video but also a color of the moving region, the video retrieval can be conducted more suitably than the case where the video retrieval is conducted based on the presence or absence of the motion or the case where the video of a particular portion of the object is needed in the video retrieval.

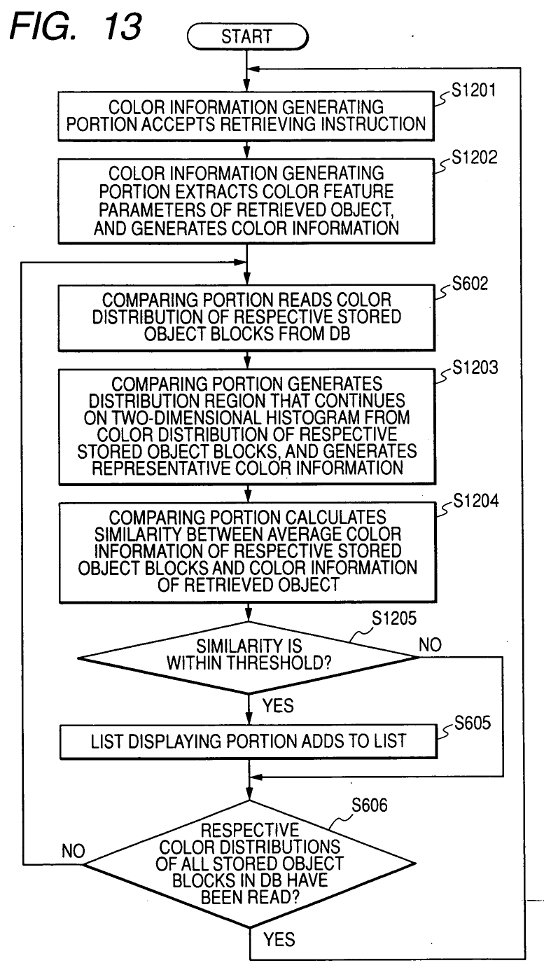

Next, a video retrieval apparatus in a third embodiment of the present invention is shown in FIG. 12. In FIG. 12, the same reference symbols as those in the video retrieval apparatus 400 are affixed to the similar constituent elements to the second embodiment, and their explanation will be omitted herein.

In FIG. 12, a video retrieval apparatus 1100 of this embodiment of the present invention includes a color information generating portion 1101 that extracts color information from the color as the retrieved object in response to the user's operation of the keyboard 107 to output it, and a comparing portion 1102 that generates average color information of the continuous distribution region from the color distribution of the stored object blocks constituting the stored object moving region in the DB 402, then comparing the retrieved object color information from the color information generating portion 1101 with the average color information of the generated stored object blocks, and then outputting the retrieved result in response to the compared result.

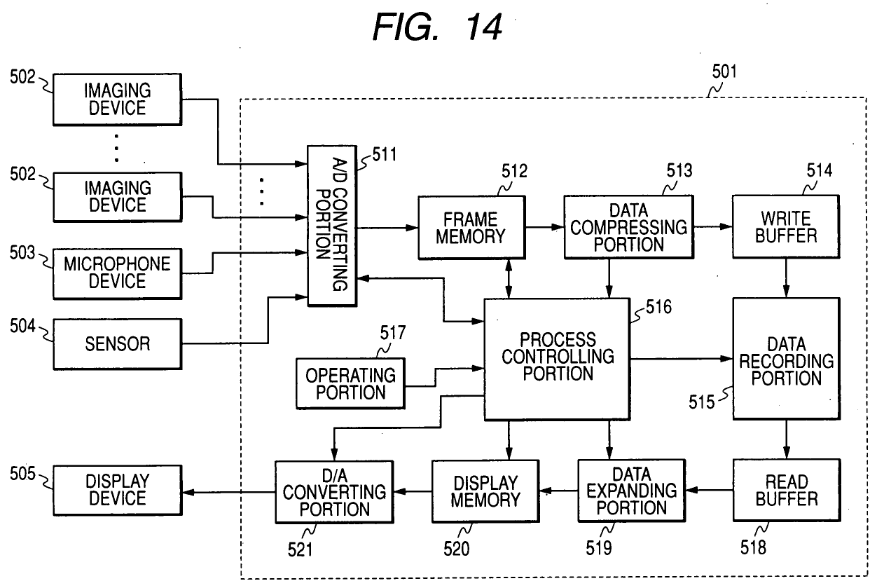

An operation of the video retrieval apparatus 1100 constructed as above will be explained with reference to FIG. 5 and FIG. 13 hereunder. The same reference symbols are affixed to the similar process steps to those in the first and second embodiments, and explanation of their operation will be simplified herein. Also, the operation in storing the color information is similar to that of the video retrieval apparatus 400 and therefore its explanation using FIG. 5 will be omitted herein.

An operation of in retrieving the video will be explained with reference to FIG. 13 hereunder.

When the user outputs the retrieval start request by operating the keyboard 107, the color information generating portion 1101 outputs the request to the displaying portion 118 to display the color information image held therein. As the color information image, the color palette used in the color setting utilized normally in a software on the PC, plural pieces of color information set previously in the retrieval system, and the like may be considered. When the user watches the displayed color information image and issues the instruction to designate the color of the retrieved object (retrieving instruction), the color information generating portion 1101 accepts the retrieving instruction issued by the user (S1201).

The retrieving instruction is issued by designating one point on the color information image. The color information generating portion 1101 acquires the RGB values of the pixels corresponding to one point designated by the user from the image displayed on the displaying portion 118, then generates the color information by converting the values into the HSV space (S1202), and then outputs the information to the comparing portion 1102. The comparing portion 1102, when receives the retrieved object color information from the color information generating portion 1101, reads the color distribution of the stored object block regions constituting any stored object moving region from the DB 402 (S602). Then, the comparing portion 1102 extracts only the color information, which has a frequency larger than a predetermined fixed value, from the color distribution of the stored object blocks read from the DB 402, and generates the representative color information in units of the color distribution region that is continued on the two-dimensional coordinates using H, S (S1203). Also, the comparing portion 1102 compares the color information of the input retrieved object with representative color information generated from the read color distribution of the stored object block regions constituting the stored object moving region, and then calculates a similarity between them (S1204). Since the retrieved object color information and the representative color information are indicated as one point on the two-dimensional coordinates using H, S respectively, a distance between these two points may be calculated.

Then, the comparing portion 1102 decides whether or not a similarity between the representative color information generated from the color distribution of the stored object block regions constituting the calculated stored object moving region and the retrieved object color information is within a predetermined threshold value (S1205). When the similarity between the representative color information generated from the color distribution of the stored object block regions constituting the stored object moving region and the retrieved object color information is within the predetermined threshold value, the comparing portion 1102 outputs the data related to the stored object moving region containing the stored object block regions constituting the stored object moving region (e.g., data of an identification information (ID) of the camera 102 that picks up the video containing the stored object moving region, a shooting data and time, and a thumbnail video in which the video of the stored object moving region is reduced) to the list displaying portion 112 as the retrieved result. The list displaying portion 112 adds the data related to the stored object moving region containing the stored object block regions constituting the stored object moving region from the comparing portion 1102 to the retrieved result list (S605).

After the list displaying portion 112 adds the data to the retrieved result list (S605) or after the comparing portion 1102 decides that the consistency similarity between the representative color information generated from the color distribution of the stored object block regions constituting the calculated stored object moving region and the retrieved object color information exceeds the predetermined threshold value (negative decision in S1204), the comparing portion 1102 decides whether or not the color distributions of the stored object block regions constituting all stored object moving regions in the DB 402 have been read (S606). When the color distribution of the stored object block regions constituting the stored object moving region that has not been read still remains in the DB 402, operations subsequent to the reading operation of the color distribution of the retrieved object block regions constituting the stored object moving region, which has not been read yet, by the comparing portion 1102 (S602) are repeated.

In contrast, when the comparing portion 1102 reads the color distribution of the stored object block regions constituting all stored object moving regions in the DB 402, operations subsequent to the acceptance of the retrieving instruction by the color information generating portion 1101 (S1201) are repeated. Then, the retrieved result list generated by the list displaying portion 112 is displayed on the displaying portion 118, so that the user can recognize the retrieved result.

In FIG. 13, the case where the user designates the color palette or the previously set color information as the retrieved object is explained. But the retrieved object color information may be generated by integrating the color distribution separately in storing the color distribution of the stored object block regions constituting the stored object region in the DB 402, and then selecting the color information having a high occurring frequency only in a predetermined fixed number. Then, the user selects one piece of color information from the retrieved object color information generated in this manner and issues the retrieving instruction.

In this manner, in the video retrieval apparatus 1100, when the moving region in the video picked up by the video inputting portion 101 satisfies the conditions required for the person, the moving region is divided into a plurality of stored object block regions and then the color distributions of the stored object block regions are generated and stored in the DB 402. Then, in retrieving the video, when the user designates one retrieved object color information, the data associated with the stored object region containing the stored object block regions constituting the stored object region that has the representative color similar to the retrieved object color information are offered to the user as the retrieved result. In other words, even though the image as the retrieved object is not present, the video retrieval is conducted based on not only the motion in the picked-up video but also the color of the moving region by instructing one point from the color information image given by the retrieval system. Therefore, the video retrieval can be conducted more suitably than the case where the video retrieval is conducted based on the presence or absence of the motion or the case where the video of the particular portion of the object is needed in the video retrieval.

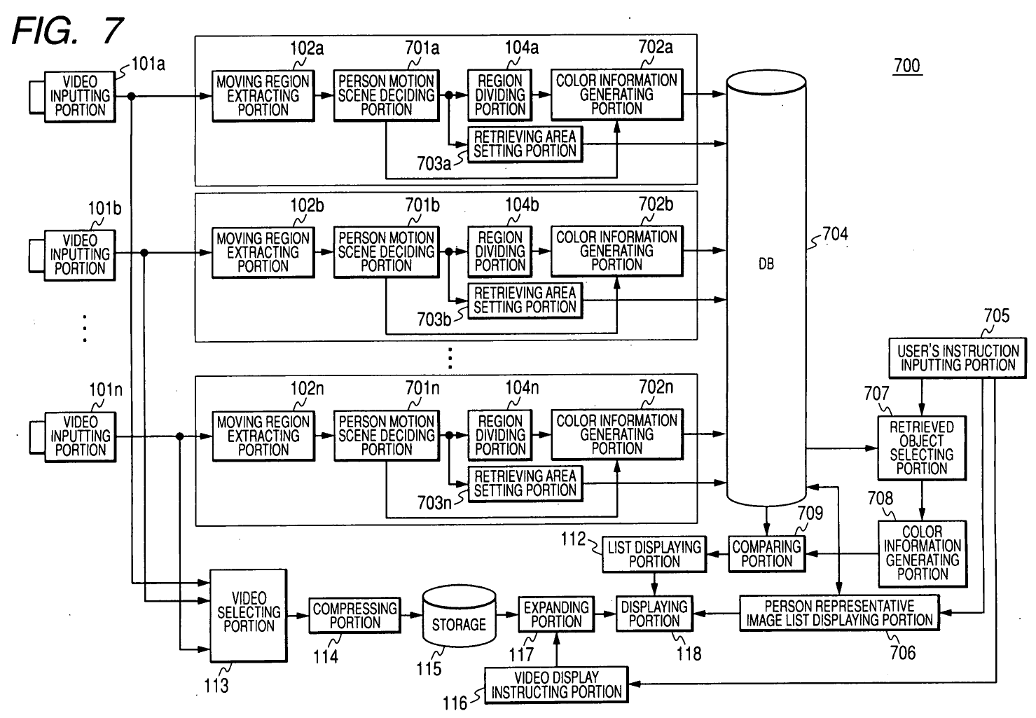

Next, a video retrieval apparatus in a fourth embodiment of the present invention is shown in FIG. 7. The same reference symbols as those in the video retrieval apparatus 100 are affixed to the similar constituent elements to the first embodiment, and their explanation will be omitted herein.

In FIG. 7, a video retrieval apparatus 700 in this embodiment of the present invention includes person motion scene deciding portions 701a to 701n that receive the stored object moving region video signal from the corresponding moving region extracting portion 102 every motion object, then decide whether or not the stored object moving region satisfies the predetermined conditions required for the person, then output the stored object moving region video signal every motion object and also decides whether or not the successively input stored object moving region satisfies the predetermined conditions required for the same person when the stored object moving region satisfies the conditions, then track the person when the person is decided as the same person, and then output a motion scene end signal when the person who is on the track disappears from the video respectively (these person motion scene deciding portions 701a to 701n are referred together to appropriately as a “person motion scene deciding portion 701” hereinafter). Also, this system includes color information generating portions 702a to 702n that receive the stored object block region video signal from the corresponding region dividing portion 104, then extract color feature parameters of the stored object block regions constituting the stored object moving region and save them every person, and then generate/output the color distribution every person when the motion scene end signal is input from the corresponding person motion scene deciding portion 701 respectively (these color information generating portions 702a to 702n are referred together to appropriately as a “color information generating portion 702” hereinafter). Also, this system includes retrieving area setting portions 703a to 703n that receive the stored object moving region video signal from the corresponding person motion scene deciding portion 701, then decide whether or not the video signal satisfies the predetermined retrieved object region setting conditions, then save the retrieved object region video signal every person when the video signal satisfies the retrieved object region setting conditions, and then output the retrieved object region video signal when the motion scene end signal is input from the corresponding person motion scene deciding portion 701 respectively (these retrieving area setting portions 703a to 703n are referred together to appropriately as a “retrieving area setting portion 703” hereinafter).

Also, the video retrieval apparatus 700 includes a database (DB) 704 for accumulating the color distribution from the color information generating portion 702 every person and the retrieved object region video signal from the retrieving area setting portion 703. Also, this system includes a user's instruction inputting portion 705 used by the user to input the instruction, and a person representative image list displaying portion 706 for reading the retrieved object region video signal as the person representative image from the DB 704 in response to the retrieval execution request made by the user and then generating a person representative image list to output it. Also, this system includes a retrieved object selecting portion 707 for reading the retrieved object region video signal corresponding to the person representative images selected by the user from the DB 704 to output it, and a color information generating portion 708 for receiving the retrieved object region video signal from the retrieved object selecting portion 707, then extracts color feature parameters of the retrieved object region, and then generates/outputs the color distribution. Also, this system includes a comparing portion 709 that compares the color distribution of the retrieved object region from the color information generating portion 708 with the color distribution of the stored object block regions constituting the stored object moving region in the DB 704, and then outputting the retrieved result in response to the compared result.

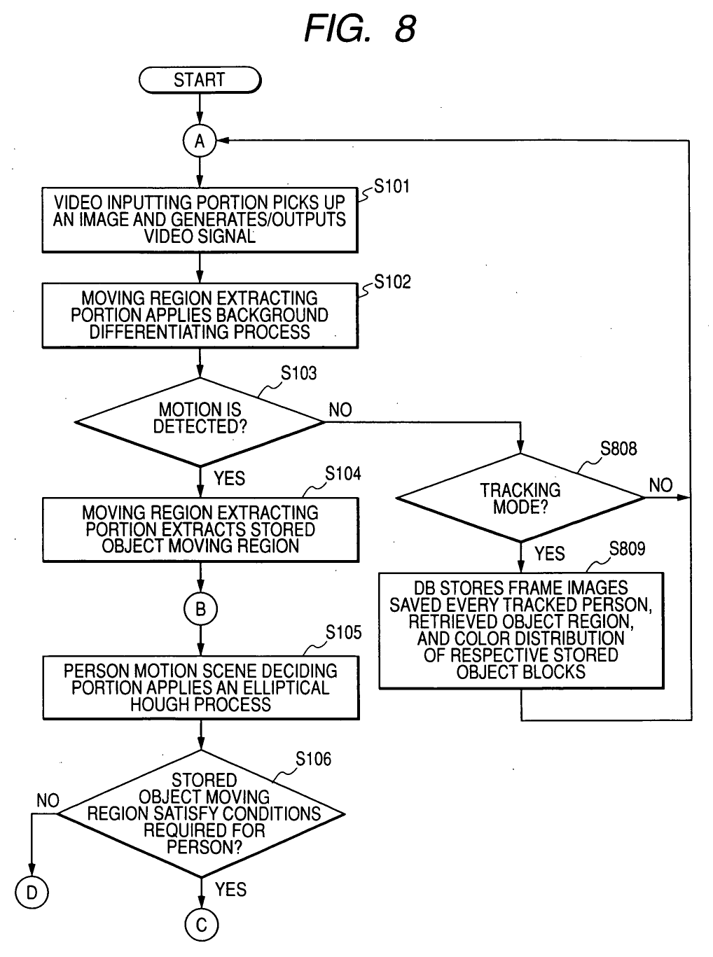

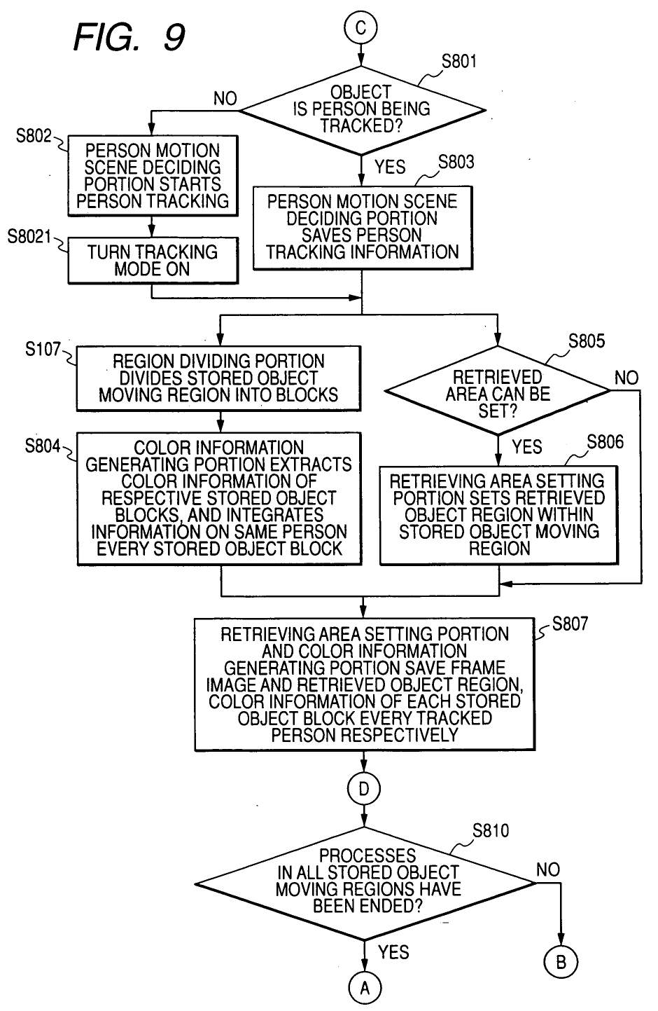

An operation of the video retrieval apparatus 700 constructed as above will be explained with reference to FIG. 8 to FIG. 10 hereunder. The same reference symbols are affixed to the similar process steps to those in the first and second embodiments, and explanation of their operation will be simplified herein. First, an operation in accumulating the color information will be explained with reference to FIG. 8 and FIG. 9 hereunder.

As shown in FIG. 8, the video inputting portion 101 picks up an image of the subject and generates a video signal (S101). Also, the video inputting portion 101 outputs the generated video signal to the corresponding moving region extracting portion 102. Then, the moving region extracting portion 102, when receives the video signal from the corresponding video inputting portion 101, applies a background differentiating process to calculate a differential value between the video corresponding to the video signal and the background video prepared previously (S102).

Then, the moving region extracting portion 102 decides whether or not a motion is detected in the video corresponding to the input video signal (S103). When no motion is detected in the video corresponding to the video signal input into the moving region extracting portion 102, the moving region extracting portion 102 informs the person motion scene deciding portion 701 that no motion has been detected.

When the person motion scene deciding portion 701 receives the signal indicating that no motion has been detected from the corresponding moving region extracting portion 102, it decides whether or not the system is in a tracking mode (S808).

When it is decided that the system is not in a tracking mode, operations subsequent to the shooting of the subject and the generation of the video signal executed by the video inputting portion 101 (S11) are repeated.

In contrast, when it is decided that the system is in a tracking mode, the person motion scene deciding portion 701 outputs the motion scene end signal to the corresponding color information generating portion 702 and the corresponding retrieving area setting portion 703.

The DB 704 stores the color distributions corresponding to the stored object block regions being output from the color information generating portion 702 and the retrieving area setting portion 703 every person, and also stores the retrieved object region video corresponding to the retrieved object region to correlate with each other (S809). Also, the tracking mode is turned OFF.

In contrast, when the motion is detected in the video corresponding to the video signal input into the moving region extracting portion 102, the moving region extracting portion 102 extracts all moving regions in the video (stored object moving regions) (S104). Also, the moving region extracting portion 102 outputs the stored object moving region video signal corresponding to all extracted stored object moving regions to the corresponding person motion scene deciding portion 701.

The person motion scene deciding portion 701, when receives all stored object moving region video signals from the corresponding moving region extracting portion 102, applies the elliptical Hough process to the video in the stored object moving region corresponding to the stored object moving region video signal (S105). Then, the person motion scene deciding portion 701 decides whether or not the input stored object moving region corresponding to all stored object moving region video signals satisfy the conditions required for the person (S106).

As shown in FIG. 9, when the stored object moving region corresponding to the stored object moving region video signals does not satisfy the conditions required for the person, it is decided whether or not the processes in all stored object moving regions have been ended (S810). When it is decided that the processes in all stored object moving regions have been ended, operations subsequent to the shooting of the subject and the generation of the video signal executed by the video inputting portion 101 (S101) are repeated. When it is decided that the processes in all stored object moving regions have not been ended, operations subsequent to the elliptical Hough process executed by the person motion scene deciding portion 701 (S105) are repeated.

In contrast, when the stored object moving region corresponding to the stored object moving region video signals satisfies the conditions required for the person, the person motion scene deciding portion 701 decides whether or not the person in the stored object moving region corresponding to the successively input stored object moving region video signals satisfies the conditions required for the same person being tracked as that in the stored object moving region (S801). Concretely, when a moving distance of the stored object moving region is within a predetermined movable distance of the person and also the continuous moving direction is not remarkably changed, it is decided that the person being on the track is the same person, based on saved position/moving information of the stored object region.

When it is decided that the person in the stored object moving region does not satisfy the conditions required for the same person, the person motion scene deciding portion starts the tracking of the person as the new tracked person (S802). Concretely, ID to identify the person is prepared and barycentric coordinates of the input stored object moving region are saved as position information in the video. In this case, if the position of the region in the video can be expressed, other information may be employed in place of the barycentric coordinates of the input stored object moving region. Also, the tracking mode is turned ON (S8021).

In contrast, when it is decided that the person in the stored object moving region satisfies the conditions required for the same person, the person motion scene deciding portion 701 outputs the input stored object moving region video signal to the corresponding region dividing portion 104 and the corresponding retrieving area setting portion 703, and saves a moving distance, a moving direction, position information, etc. from the preceding frame based on the saved position information of the stored object moving region as person tracking information (S803).

The region dividing portion 104 receives all stored object moving region video signals from the corresponding person motion scene deciding portion 701, and divides the stored object moving region corresponding to the stored object moving region video signals into a plurality of blocks (stored object block regions) (S107). Then, the region dividing portion 104 outputs the video signal corresponding to the stored object block regions constituting the stored object block region (stored object block region video signal) to the corresponding color information generating portion 702.

When the stored object block region video signals corresponding to the stored object block regions constituting all stored object moving region is input from the corresponding region dividing portion 104, the color information generating portion 702 extracts the color information of respective stored object block regions constituting the stored object moving region based on the stored object block region video signals, and integrates the color information on the same saved person every stored object block region (S804). Concretely, the color information generating portion 702 acquires RGB values of respective pixels of the stored object block region as the color information, then converts them into the HSV space to form the histogram by using H, S (called the “color distribution” hereinafter), and then integrates the color distribution corresponding to a plurality of stored object block regions constituting the stored object moving region every same person being on the track. Here, the color space is converted from RGB to HSV, but other color spaces (e.g., XYX, YcrCb, or the like) can also be utilized by the normal usage (the histogram is generated by the XY plane, the CrCb plane).

Finally, the color information generating portion 702 saves the color information corresponding to the stored object blocks every tracked person respectively (S807). In contrast, when the motion scene end signal is input from the corresponding person motion scene deciding portion 701, the color information generating portion 702 normalizes the saved color distribution corresponding to the stored object block regions every person being on the track and outputs the distribution to the DB 704.

When all stored object moving region video signals are input from the person motion scene deciding portion 701, the retrieving area setting portion 703 decides whether or not the retrieved object area can be set based on the previously set rule (S805). Concretely, the retrieving area setting portion 703 decides based on a previously set threshold value whether or not the retrieved object area can be set by using a position and a size of the stored object moving region corresponding the input stored object moving region signal.

The retrieving area setting portion 703 ends the process when it decides that the retrieved object area cannot be set, while the retrieving area setting portion 703 sets the retrieved object region within the stored object moving region (S806) when it decides that the retrieved object area can be set. Finally, the retrieved object region video signal corresponding to the retrieved object region being saved every tracked person is saved (S807). At this time, if the retrieved object region video signal corresponding to the new retrieved object region is compared with the retrieved object region video signal corresponding to the retrieved object region that has already been save and then the video signal that is closer to the previously set condition (e.g., averages of luminance/saturation of the overall retrieved object region video signal are closer to a previously set value) should be saved, the retrieved object region video signal corresponding to the best retrieved object region can always be saved.

After the above processes in S101 to S106, S801 to S810 are repeated, the color distributions of the stored object block regions constituting a plurality of stored object moving regions and the retrieved object region videos corresponding to the retrieved object region are accumulated in the DB 704 respectively.

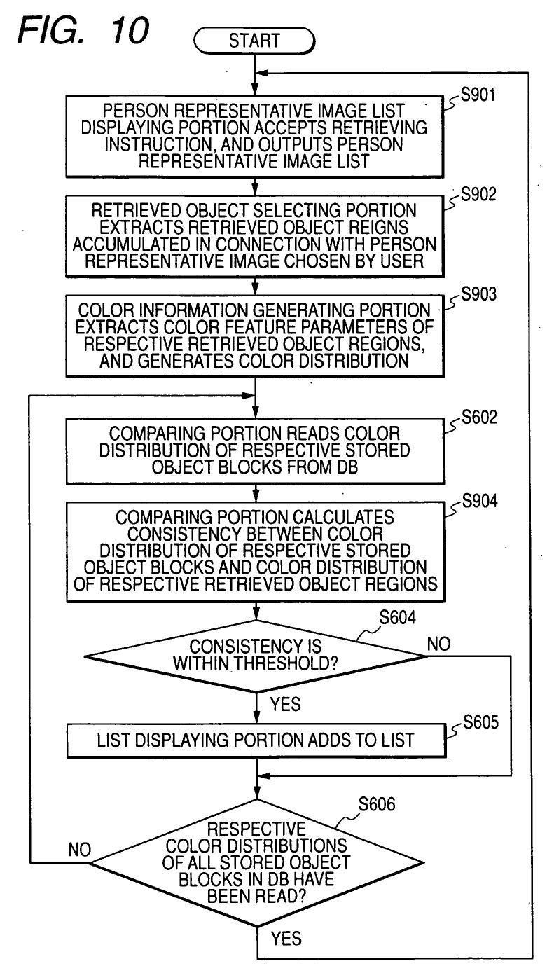

Next, an operation in retrieving the video will be explained with reference to FIG. 10 hereunder.

When the user issues the retrieval request by using the user's instruction inputting portion 705, the person representative image list displaying portion 706 accepts the user's request (S901). The person representative image list displaying portion 706 acquires the retrieved object region video signal accumulated in the DB 704 as the representative image, then forms a list (person representative image list), and then outputs the list to the displaying portion 118. The displaying portion 118 displays the person representative image list. The user watches the displayed person representative image list, and inputs the instruction from the user's instruction inputting portion 705 to select any one of the person representative images.

When the instruction to select the person representative image is input from the user's instruction inputting portion 705, the retrieved object selecting portion 707 acquires the retrieved object reign and the retrieved object region video signal corresponding to the person representative image chosen by the user from the DB 704, and outputs them (S902).

When the retrieved object region video signal is input from the retrieved object selecting portion 707, the color information generating portion 708 extracts the color information of the retrieved object reign (S903). Concretely, the color information generating portion 702 acquires the RGB values of respective pixels of the stored object block region as the color information, and then converts them into the HSV space to form the histogram by using H, S (color distribution). In addition, the color information generating portion 702 integrates the histogram corresponding to a plurality of stored object block regions constituting the stored object moving region every same person being on the track and every stored object block region. Here, the color space is converted from RGB to HSV, but the color space may be converted into other color spaces (e.g., XYX, YcrCb, or the like) to generate the histogram (the XY plane, the CrCb plane). Then, the color information generating portion 708 outputs the color distribution to the comparing portion 709.

The comparing portion 709, when receives the color distribution of the retrieved object region from the color information generating portion 708, reads the color distribution of respective stored object block regions constituting any stored object moving region from the DB 704 (S602).

Then, the comparing portion 709 compares the color distribution of the stored object block regions constituting the read stored object moving region and the color distribution of the input retrieved object region, and then calculates a consistency between them (S904).

Since the color distribution is two-dimensional histogram using H, S, the histogram intersection may be employed to calculate a consistency. A consistency is given as the value obtained by integrating all frequencies contained in the color distribution when both color distributions are completely consistent, and a consistency becomes 0 when both color distributions are completely inconsistent.

Consistencies (partial consistencies) between respective color distributions of the stored object block regions constituting the stored object moving region and the color distribution of the retrieved object block regions constituting the retrieved object region are derived, and the consistency is calculated by integrating all partial consistencies. Here the consistency is calculated by integrating all partial consistencies, but the stored object block regions are selected as the comparative object in answer to the purpose to calculate the partial consistency and then the consistency can be calculated by integrating only the calculated partial consistencies. Alternately, all partial consistencies are calculated and then the highest partial consistency among them can be selected as the consistency.

Then, the comparing portion 709 decides whether or not the consistency between the color distribution of the stored object block regions constituting the calculated stored object moving region and the color distribution of the retrieved object region is within a predetermined threshold value (S604). Here, it is desirable that the user can set freely the threshold value.

When the consistency between the color distribution of the stored object block regions constituting the stored object moving region and the color distribution of the retrieved object region is within the predetermined threshold value, the comparing portion 709 outputs the data related to the stored object moving region containing the stored object block regions constituting the stored object moving region (e.g., data of an identification information (ID) of the camera 102 that picks up the video containing the stored object moving region, a shooting data and time, and a thumbnail video in which the video of the stored object moving region is reduced) to the list displaying portion 112 as the retrieved result. The list displaying portion 112 adds the data related to the stored object moving region containing the stored object block regions constituting the stored object moving region from the comparing portion 709 to the retrieved result list (S605).

After the list displaying portion 112 adds the data to the retrieved result list (S605) or after the comparing portion 709 decides that the consistency between the color distribution of the stored object block regions constituting the stored object moving region and the color distribution of the retrieved object region exceeds the predetermined threshold value (negative decision in S604), the comparing portion 709 decides whether or not the color distributions of the stored object block regions constituting all stored object moving regions in the DB 704 have been read (S606). When the color distribution of the stored object block regions constituting the stored object moving region that has not been read remains in the DB 704, operations subsequent to the reading operation of the color distribution of the retrieved object block regions constituting the stored object moving region, which has not been read yet, by the comparing portion 709 (S602) are repeated.

In contrast, when the comparing portion 709 reads the color distribution of the stored object block regions constituting all stored object moving regions in the DB 704, operations subsequent to the acceptance of the retrieving instruction by the person representative image list displaying portion 706 (S901) are repeated. Then, the retrieved result list generated by the list displaying portion 112 is displayed on the displaying portion 118, so that the user can recognize the retrieved result.

In this manner, in the video retrieval apparatus 700, when the moving region in the video picked up by the video inputting portion 101 satisfies the conditions required for the person, the moving region is divided into a plurality of stored object block regions, and the color information of the stored object bock regions is extracted. Then, when it is decided that the person is the same person, the color distributions of the stored object block regions constituting respective moving regions of a series of motion scenes of the person are generated, and at the same time the retrieved object region video signals corresponding to the best retrieved object region among a series of motion scenes of the person are stored in the DB 704. Then, in retrieving the video, the color distribution of the retrieved object region of the person is generated automatically when the user designates the retrieved object person image from the person representative image list displayed on the displaying portion 118, and then the data associated with the stored object region containing the stored object block regions constituting the stored object region that are similar to the color distribution of the retrieved object region are offered to the user as the retrieved result. In other words, since not only the retrieval can be conducted by a motion in the picked-up video or a color of the moving region but also the retrieval can be conducted by using one retrieved object region that is set among a series of motion scenes of the person, the video retrieval can be conducted more suitably than the case where the video retrieval is conducted based on the presence or absence of the motion or the case where the video of a particular portion of the object is needed in the video retrieval. In addition, although the user neither looks for a desired retrieved object region while reproducing the video in setting the retrieved region nor selects the retrieved object region by watching repeatedly the video of the same person, he or she can execute the retrieval by designating the desired person image as the retrieved object region. Further, the user never gets different result every time when he or she conducts the retrieval, and thus the user can get always the stable retrieved result.

In the above explanation, upon retrieving the video, the retrieved object selecting portion 707 acquires the retrieved object region and the retrieved object region video signal corresponding to the person representative image designated by the user from the DB 704, and then generates the color distribution. However, upon recording the video, the retrieving area setting portion 703 may execute the process up to the generation of the color distribution of the retrieved object region, and then may store the color distribution and the retrieved object video signal in the DB 704 to correlate with each other.

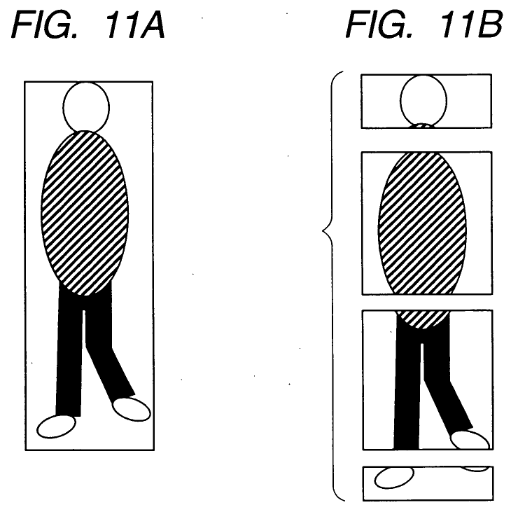

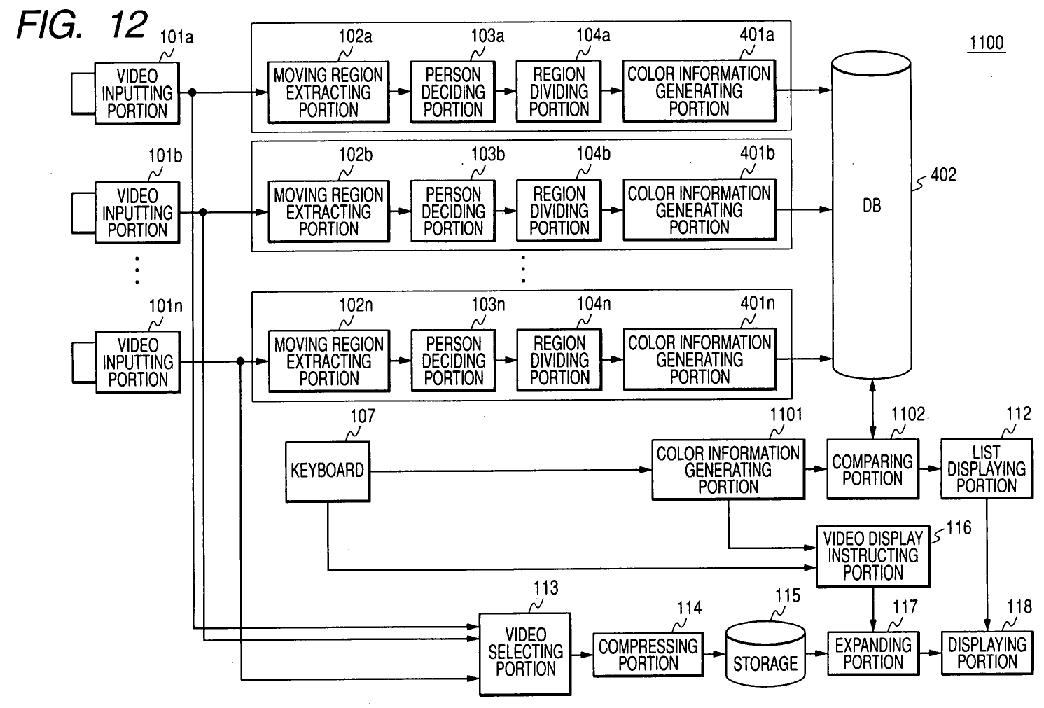

Also, in the first to fourth embodiments, as shown in FIG. 11, the region dividing portion 104 sets the stored object region being output by the person motion scene deciding portion 701 as the person region (a), and the person motion scene deciding portion 701 outputs an elliptic position and a size derived by the elliptical Hough process. Then, the region dividing portion 104 divides the region based on the elliptic position and the size, as shown in (b), and outputs the stored object block region and the stored object block region video signal, and the color information generating portion 702 generates/outputs the color distribution every stored object block region. Similarly, the retrieving area setting portion 703 divides the retrieved object region as shown in FIG. 11 and outputs the retrieved object block region video signals corresponding to the retrieved object region, and the DB 704 stores four color distributions and retrieved object regions in one motion scene to correlate with the retrieved object block region video signals. The comparing portion 709 compares the color distributions of the retrieved object block regions corresponding to the stored object block regions mutually. Accordingly, when the user selects the person representative image as the retrieved object on the monitor, such user may select the person representative image by designating chosen items of the split regions such as head, upper half of the body, lower half of the body, shoes, and the like. As a result, the retrieval can be conducted based on a color of a partial dress of the person or combination of colors of the dresses of a plurality of persons.

Also, in the fourth embodiment, such a configuration may be employed that a size of the stored object block is fixed while the tracking mode is being turned ON.

The present invention is explained in detail with reference to particular embodiments, but it is obvious for those skilled in the art that various variation and modifications can be applied without departing a spirit and a scope of the present invention This application is based upon Japanese Patent Application (Patent Application No. 2004-358526) filed on Dec. 10, 2004, and the contents thereof are incorporated herein by reference.

### INDUSTRIAL APPLICABILITY

As described above, the video retrieval apparatus and the video retrieval method according to the present invention possess such advantages that the video retrieval can be carried out appropriately and also the retrieved object to retrieve effectively the videos of the persons who are dressed in similar colors can be easily designated, and are useful for a video retrieval apparatus and a video retrieval method that are used for the video monitoring purpose in the individual identification, and the like.

What is claimed is:

1. A video retrieval apparatus, comprising:
a stored object moving region extracting unit that extracts a stored object moving region in a first video, and outputs a stored object moving region video signal corresponding to the stored object moving region;
a stored object block region dividing unit that divides the stored object moving region into stored object block regions based on the stored object moving region video signal, and outputs stored object block region video signals corresponding to respective stored object block regions constituting the stored object moving region;
a stored object block region representative color deriving unit that derives representative colors of respective stored object block regions constituting the stored object moving region based on the stored object block region video signals corresponding to respective stored object block regions to output;
a stored object block region representative color storing unit that stores respective representative colors of the stored object block regions;
a retrieved object region extracting unit that extracts a retrieved object region in a second video, and outputs a retrieved object region video signal corresponding to the retrieved object region;
a retrieved object block region dividing unit that divides the retrieved object region into retrieved object block regions based on the retrieved object region video signal, and outputs retrieved object block region video signals corresponding to respective retrieved object block regions constituting the retrieved object region;
a retrieved object block region representative color deriving unit that derives representative colors of respective retrieved object block regions constituting the retrieved object region based on the retrieved object block region video signals corresponding to respective retrieved object block regions to output; and
a comparing unit that compares respective representative colors of the stored object block regions with respective representative colors of the retrieved object block regions, and outputs compared results.

2. The video retrieval apparatus according to claim 1, wherein the comparing unit derives differential values between respective representative colors of the stored object block regions and respective representative colors of the retrieved object block regions as the compared results.

3. The video retrieval apparatus according to claim 1, further comprising:
a person deciding unit that decides whether or not the stored object moving region satisfies predetermined conditions being set previously as conditions in which the stored object moving region is a person, based on the stored object moving region video signal, and outputs the stored object moving region video signal to the stored object block region dividing unit when the stored object moving region satisfies the predetermined conditions.

4. The video retrieval apparatus according to claim 1, wherein the stored object block region representative color deriving unit derives either a color corresponding to an average value of values, which are obtained by a conversion scheme to reduce an influence of a luminance change of occurring colors in the stored object block regions or a color having a highest occurring frequency of the obtained values as the representative colors of the stored object block regions.

5. The video retrieval apparatus according to claim 1, wherein the retrieved object block region representative color deriving unit derives either a color corresponding to an average value of values which are obtained by a conversion scheme to reduce an influence of a luminance change of occurring colors in the retrieved object block regions or a color having a highest occurring frequency of the obtained values as the representative colors of the retrieved object block regions.

6. A video retrieval method of retrieving a motion object in a first video based on information in a second video, comprising:
a stored object moving region extracting step of extracting a stored object moving region in a first video, and outputting a stored object moving region video signal corresponding to the stored object moving region;
a stored object block region dividing step of dividing the stored object moving region into stored object block regions based on the stored object moving region video signal, and outputting stored object block region video signals corresponding to respective stored object block regions constituting the stored object moving region;
a stored object block region representative color deriving step of deriving representative colors of respective stored object block regions constituting the stored object moving region based on the stored object block region video signals corresponding to respective stored object block regions to output;
a stored object block region representative color storing step of storing respective representative colors of the stored object block regions;
a retrieved object region extracting step of extracting a retrieved object region in a second video, and outputting a retrieved object region video signal corresponding to the retrieved object region;
a retrieved object block region dividing step of dividing the retrieved object region into retrieved object block regions based on the retrieved object region video signal, and outputting retrieved object block region video signals corresponding to respective retrieved object block regions constituting the retrieved object region;
a retrieved object block region representative color deriving step of deriving representative colors of respective retrieved object block regions constituting the retrieved object region based on the retrieved object block region video signals corresponding to respective retrieved object block regions to output; and
a comparing step of comparing respective representative colors of the stored object block regions with respective representative colors of the retrieved object block regions, and outputting compared results.

7. The video retrieval method according to claim 6, wherein the comparing step derives differential values between respective representative colors of the stored object block regions and respective representative colors of the retrieved object block regions as the compared results.

8. The video retrieval method according to claim 6, further comprising:
a person deciding step of deciding whether or not the stored object moving region satisfies predetermined conditions being set previously as conditions in which the stored object moving region is a person, based on the stored object moving region video signal, and outputs the stored object moving region video signal when the stored object moving region satisfies the predetermined conditions;
wherein, when the stored object moving region video signal is output in the person deciding step, the stored object block region dividing step divides the stored object moving region into stored object block regions based on the stored object moving region video signal, and outputs stored object block region video signals corresponding to respective stored object block regions constituting the stored object moving region.

9. A video retrieval apparatus, comprising:
a stored object moving region extracting unit that extracts a stored object moving region in a first video, and outputs a stored object moving region video signal corresponding to the stored object moving region;
a stored object block region dividing unit that divides the stored object moving region into stored object block regions based on the stored object moving region video signal, and outputs stored object block region video signals corresponding to respective stored object block regions constituting the stored object moving region;
a stored object block region color information generating unit that extracts color distributions from video signals contained in respective stored object block regions constituting the stored object moving region based on the stored object block region video signals corresponding to respective stored object block regions to output;
a stored object block region color information storing unit that stores respective color information of the stored object block regions;
a retrieved object region extracting unit that extracts a retrieved object region in a second video, and outputs a retrieved object region video signal corresponding to the retrieved object region;
a retrieved object block region dividing unit that divides the retrieved object region into retrieved object block regions based on the retrieved object region video signal, and outputs retrieved object block region video signals corresponding to respective retrieved object block regions constituting the retrieved object region;
a retrieved object block region color information generating unit that extracts color distributions from video signals contained in respective retrieved object block regions constituting the retrieved object region based on the retrieved object block region video signals corresponding to respective retrieved object block regions to output; and
a comparing unit that compares respective color distributions of the stored object block regions with respective color distributions of the retrieved object block regions, and outputs compared results.

10. The video retrieval apparatus according to claim 9, wherein the comparing unit derives consistencies in a color occurring frequency between respective color distributions of the stored object block regions and respective color distributions of the retrieved object block regions as the compared results.

11. The video retrieval apparatus according to claim 9, wherein the comparing unit derives a consistency in a color occurring frequency between respective color distributions of the stored object block regions and any of color distributions of the retrieved object block regions as the compared results.

12. The video retrieval apparatus according to claim 9, further comprising:
a person deciding unit that decides whether or not the stored object moving region satisfies predetermined conditions being set previously as conditions in which the stored object moving region is a person, based on the stored object moving region video signal, and outputs the stored object moving region video signal to the stored object block region dividing unit when the stored object moving region satisfies the predetermined conditions.

13. A video retrieval apparatus, comprising:
a stored object moving region extracting unit that extracts a stored object moving region in a first video, and outputs a stored object moving region video signal corresponding to the stored object moving region;
a stored object block region dividing unit that divides the stored object moving region into stored object block regions based on the stored object moving region video signal, and outputs stored object block region video signals corresponding to respective stored object block regions constituting the stored object moving region;
a stored object block region color information generating unit that extracts color distributions from video signals contained in respective stored object block regions constituting the stored object moving region based on the stored object block region video signals corresponding to respective stored object block regions to output;
a stored object block region color information storing unit that stores respective color information of the stored object block regions;
a retrieved object color information generating unit that extracts one retrieving object point in a second video, and extracts color information of the retrieving object point based on the retrieved object region video signal corresponding to the retrieved object point to output; and
a comparing unit that generates representative color information from respective color distributions of the stored object block regions, compares the representative color information with the retrieved object color information, and outputs compared results.

14. The video retrieval apparatus according to claim 13, wherein the comparing unit derives similarities of a color occurring frequency between the representative color information generated from respective color distributions of the stored object block regions and the color information of the retrieving object point as the compared results.

15. A video retrieval apparatus, comprising:
a stored object moving region extracting unit that extracts a stored object moving region in a video, and outputs a stored object moving region video signal corresponding to the stored object moving region;
a person motion scene deciding unit that identifies a same person from successive frame images in the video based on the stored object moving region video signal, and outputs the stored object moving region video signal and also outputs a motion scene end signal at a point of time when no motion is detected;
a stored object block region dividing unit that divides the stored object moving region into stored object block regions based on the stored object moving region video signal, and outputs stored object block region video signals corresponding to respective stored object block regions constituting the stored object moving region;
a stored object block region color information generating unit that extracts color feature parameters from video signals contained in respective stored object block regions constituting the stored object moving region every same person based on the stored object block region video signals corresponding to respective stored object block regions, and generates color distributions corresponding to respective stored object block regions every same person in response to the motion scene end signal to output;
a retrieving area setting unit that sets a retrieved object region every same person based on the stored object moving region video signal, and outputs a retrieved object region video signal corresponding to the retrieved object region every same person in response to the motion scene end signal;
a region color information storing unit that stores respective color information of the stored object block regions and the retrieved object region video signal corresponding to the retrieved object region;
a person representative image list displaying unit that acquires the retrieved object region video signal from the region color information storing unit, and outputs a display list;
a retrieved object region color information generating unit that generates a color distribution from a video signal contained in the retrieved object region based on the retrieved object region video signal to output; and
a comparing unit that compares respective color distributions of the stored object block regions with respective color distributions of the retrieved object block regions, and outputs compared results.

16. The video retrieval apparatus according to claim 12, wherein the stored object block region dividing unit decides divided positions according to a shape of the person.

17. A video retrieval method of retrieving a motion object in a first video based on information in a second video, comprising:
a stored object moving region extracting step of extracting a stored object moving region in a first video, and outputting a stored object moving region video signal corresponding to the stored object moving region;
a stored object block region dividing step of dividing the stored object moving region into stored object block regions based on the stored object moving region video signal, and outputting stored object block region video signals corresponding to respective stored object block regions constituting the stored object moving region;
a stored object block region color information generating step of extracting color distributions from video signals contained in respective stored object block regions constituting the stored object moving region based on the stored object block region video signals corresponding to respective stored object block regions to output;
a stored object block region color information storing step of storing respective color information of the stored object block regions in a stored object block region storing unit;
a retrieved object region extracting step of extracting a retrieved object region in a second video, and outputting a retrieved object region video signal corresponding to the retrieved object region;
a retrieved object block region dividing step of dividing the retrieved object region into retrieved object block regions based on the retrieved object region video signal, and outputting retrieved object block region video signals corresponding to respective retrieved object block regions constituting the retrieved object region;
a retrieved object block region color information generating step of extracting color distributions from video signals contained in respective retrieved object block regions constituting the retrieved object region based on the retrieved object block region video signals corresponding to respective retrieved object block regions to output; and
a comparing step of comparing respective color distributions of the stored object block regions with respective color distributions of the retrieved object block regions, and outputting compared results.

18. The video retrieval method according to claim 17, wherein the comparing step derives consistencies in a color occurring frequency between respective color distributions of the stored object block regions and respective color distributions of the retrieved object block regions as the compared results.

19. The video retrieval method according to claim 17, wherein the comparing step derives a consistency in a color occurring frequency between respective color distributions of the stored object block regions and any of color distributions of the retrieved object block regions as the compared results.

20. The video retrieval method according to claim 17, further comprising:
a person deciding step of deciding whether or not the stored object moving region satisfies predetermined conditions being set previously as conditions in which the stored object moving region is a person, based on the stored object moving region video signal, and outputting the stored object moving region video signal when the stored object moving region satisfies the predetermined conditions;
wherein, when the stored object moving region video signal is output in the person deciding step, the stored object block region dividing step divides the stored object moving region into stored object block regions based on the stored object moving region video signal, and outputs stored object block region video signals corresponding to respective stored object block regions constituting the stored object moving region.

21. A video retrieval method, comprising:
a stored object moving region extracting step of extracting a stored object moving region in a first video, and outputting a stored object moving region video signal corresponding to the stored object moving region;
a stored object block region dividing step of dividing the stored object moving region into stored object block regions based on the stored object moving region video signal, and outputting stored object block region video signals corresponding to respective stored object block regions constituting the stored object moving region;
a stored object block region color information generating step of extracting color distributions from video signals contained in respective stored object block regions constituting the stored object moving region based on the stored object block region video signals corresponding to respective stored object block regions to output;
a stored object block region color information storing step of storing respective color information of the stored object block regions;
a retrieved object color information generating step of extracting one retrieving object point in a second video, and extracting color information of the retrieving object point based on the retrieved object region video signal corresponding to the retrieved object point to output; and
a comparing step of generating representative color information from respective color distributions of the stored object block regions, comparing the representative color information with the retrieved object color information, and outputting compared results.

22. The video retrieval method according to claim 21, wherein the comparing step derives similarities of a color occurring frequency between the representative color information generated from respective color distributions of the stored object block regions and the color information of the retrieving object point as the compared results.

23. A video retrieval method, comprising:
a stored object moving region extracting step of extracting a stored object moving region in a video, and outputting a stored object moving region video signal corresponding to the stored object moving region;
a person motion scene deciding step of identifying a same person from successive frame images in the video based on the stored object moving region video signal, and outputting the stored object moving region video signal and also outputting a motion scene end signal at a point of time when no motion is detected;
a stored object block region dividing step of dividing the stored object moving region into stored object block regions based on the stored object moving region video signal, and outputting stored object block region video signals corresponding to respective stored object block regions constituting the stored object moving region;
a stored object block region color information generating step of extracting color feature parameters from video signals contained in respective stored object block regions constituting the stored object moving region every same person based on the stored object block region video signals corresponding to respective stored object block regions, and generating color distributions corresponding to respective stored object block regions every same person in response to the motion scene end signal to output;
a retrieving area setting step of setting a retrieved object region every same person based on the stored object moving region video signal, and outputting a retrieved object region video signal corresponding to the retrieved object region every same person in response to the motion scene end signal;
a region color information storing step of storing respective color information of the stored object block regions and the retrieved object region video signal corresponding to the retrieved object region;
a person representative image list displaying step of acquiring the retrieved object region video signal from the region color information storing unit, and outputs a display list;
a retrieved object region color information generating step of generating a color distribution from a video signal contained in the retrieved object region based on the retrieved object region video signal to output; and
a comparing step of comparing respective color distributions of the stored object block regions with respective color distributions of the retrieved object block regions, and outputting compared results.
